(19) United States
(12) Patent Application Publication
(10) Pub. No.: US 2026/0287002 A1
(43) Pub. Date: Sep. 24, 2026

(54) LIMITING STRUCTURE

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/571,569

(22) Filed: Mar. 19, 2026

(30) Foreign Application Priority Data
Mar. 20, 2025 (TW) 114110537

(51) Int. Cl. F16B 21/06; F16B 21/07

(52) U.S. Cl. CPC F16B 21/065; F16B 21/076

(57) ABSTRACT

A limiting structure includes a body portion, a stop portion, a fastening portion, and an elastic element. The elastic element is configured to raise or spring up the stop portion, so that the fastening portion is configured to perform snap-locking, limiting, or engagement at a compressed position, a non-spring-up position, or a non-raised position of the stop portion. In this way, when the fastening portion engages with the stop portion, the elastic element can be compressed, and the stop portion can be limited to the non-raised position. When the fastening portion disengages from the stop portion, the elastic element can spring up the stop portion to a raised position, so that a force can be applied to the stop portion to move at least one object, thereby achieving an effect of easy operation and use.

### CROSS-REFERENCE TO RELATED APPLICATION

This non-provisional application claims priority under 35 U.S.C. § 119(a) on Patent Application No(s). 114110537 filed in Taiwan, R.O.C. on Mar. 20, 2025, the entire contents of which are hereby incorporated by reference.

### BACKGROUND OF THE INVENTION

### 1. Field of the Invention

The present disclosure provides a limiting structure, and in particular, a limiting structure capable of achieving easy operation and use.

### 1. Description of the Related Art

Generally, a fixed handle is arranged on an ordinary object, to be used for force application when the object is moved.

Although the foregoing conventional fixed handle can be used as a place for force application when the object is moved, because the fixed handle easily causes interference with another object, uneasy operation and use may occur.

### BRIEF SUMMARY OF THE INVENTION

In view of the foregoing related art, the inventor develops a limiting structure, to locate the limiting structure at a non-raised position or a raised position through engagement or disengagement, to further apply a force to move at least one object, thereby achieving an effect of easy operation and use.

To achieve the foregoing objective and other objectives, the present disclosure provides a limiting structure. The limiting structure includes a body portion, a stop portion, a fastening portion, and an elastic element. The stop portion is movably connected to the body portion. The fastening portion is connected to the body portion, the stop portion, or an object. One end of the elastic element abuts against the body portion, the stop portion, or the object, and an other end of the elastic element abuts against the stop portion, the body portion, or the fastening portion. The elastic element is configured to raise or spring up the stop portion. The fastening portion is configured to perform snap-locking, limiting, engagement, or squeezing at a compressed position, a non-spring-up position, a low position, a high position, a raised position, or a non-raised position of the stop portion or the body portion.

The present disclosure provides another limiting structure. The limiting structure includes a body portion, a stop portion, a fastening portion, and an elastic element. The stop portion is movably connected to the body portion. The fastening portion is connected to the body portion, the stop portion, or an object. One end of the elastic element abuts against the body portion, the stop portion, or the object, and an other end of the elastic element abuts against the stop portion, the body portion, or the fastening portion. The elastic element is configured to raise or apply an elastic force to the stop portion, the body portion, or an object.

The present disclosure provides another limiting structure. The limiting structure includes a body portion, a stop portion, a fastening portion, or an elastic element. The stop portion is movably connected to the body portion. The fastening portion is connected to the body portion, the stop portion, or an object. One end of the elastic element abuts against the body portion, the stop portion, or the object, and an other end of the elastic element abuts against the stop portion.

The present disclosure provides another limiting structure. The limiting structure includes a body portion, a stop portion, a fastening portion, and an elastic element. The stop portion is movably connected to the body portion. The fastening portion is connected to the body portion, the stop portion, or an object. One end of the elastic element abuts against the body portion, the stop portion, or the object, and an other end of the elastic element abuts against the stop portion, the body portion, or the fastening portion.

The present disclosure provides a limiting method of a limiting structure. The elastic element is configured to raise or spring up the stop portion, so that the fastening portion is configured to perform snap-locking, limiting, or engagement at a compressed position, a non-spring-up position, a low position, a high position, a raised position, or a non-raised position of the stop portion.

In the foregoing limiting structure, the stop portion is at a spring-up position or a raised position, and configured to locate the fastening portion to at a non-snap-locked position or a non-limit position.

In the foregoing limiting structure, the body portion or the stop portion includes an arrangement portion, where the arrangement portion is configured to allow the fastening portion or the elastic element to pass through, for the fastening portion or the elastic element to reach a placement portion for arrangement; or the body portion or the stop portion includes an arrangement portion, where the arrangement portion is configured to allow the fastening portion to pass through in a free-fall manner, for the fastening portion or the elastic element to reach a placement portion for arrangement; or the body portion or the stop portion includes an arrangement portion, and is configured to allow a tool to pass the fastening portion or the elastic element through the arrangement portion, for the fastening portion or the elastic element to reach a placement portion for arrangement.

In the foregoing limiting structure, the fastening portion is an elastic body or an object having an elastic element, or the elastic element is a spring, a torsion spring, or an elastic columnar body.

In the foregoing limiting structure, a limiting portion is arranged on the body portion, and the limiting portion is configured to perform movable limiting together with the stop portion, or two or more body portions are provided.

In the foregoing limiting structure, the limiting structure is arranged on an object, or a connecting portion connected to the object is arranged on the limiting structure, where the object is a circuit board, a metal body, a plastic body, a chip, a heat-dissipating body, a heat-generating body, or a conductive body, or the limiting structure is a handle, a fastening body, a telescopic body, or a lifting body.

In the foregoing limiting structure, the fastening portion is integrally molded or molded in a combined manner, or the fastening portion is combined by using a combination portion, or the fastening portion applies elasticity with an elastic piece, or the fastening portion is an elastic body injection molded from plastic.

In the foregoing limiting structure, a first anti-rotation portion for preventing rotation of the fastening portion is arranged on the stop portion, and the first anti-rotation portion and a limiting portion of the body portion are located in a same axial direction, and are configured to first prevent rotation and then perform limiting.

In the foregoing limiting structure, a first anti-rotation portion is arranged on the stop portion, or a second anti-rotation portion is arranged on the body portion, or a third anti-rotation portion is arranged on the fastening portion, or a fourth anti-rotation portion is arranged on an object, where the first anti-rotation portion, the second anti-rotation portion, the third anti-rotation portion, and the fourth anti-rotation portion are configured to limit a direction, a position, or an orientation.

In the foregoing limiting structure, the fastening portion is a fastening body greater than 180 degrees, or the fastening portion is a barbed structure, and is configured to apply a force to press down the stop portion to release the fastening portion.

In the foregoing limiting structure, the stop portion is operated to raise the stop portion by more than 3 mm, or the stop portion is higher than a height of a heat-dissipating body, a memory, a chip, a main board, a connector, or an element arranged on an object, or the stop portion is configured to lift or operate the object.

In the foregoing limiting structure, the fastening portion is configured to be engaged with or limited to a limiting portion of the stop portion, or the fastening portion is configured to be laterally or rotatably engaged with or limited to a limiting portion of the stop portion, or two limiting portions are provided, where one limiting portion is located at an upper position, and the other limiting portion is located a lower position and is configured to limit the fastening portion at the lower position or the upper position.

In the foregoing limiting structure, the body portion is configured to be riveted to, expansion-connected to, welded to, locked to, or engaged with the body portion, or the body portion is integrally molded with the object.

In the foregoing limiting structure, the fastening portion is connected to the body portion or is integrally molded with the body portion, or the elastic element is connected to the body portion or the fastening portion, or the elastic element is integrally molded with the body portion or the fastening portion, or the fastening portion is combined with the body portion, or the fastening portion is integrally molded with the object, or the elastic element is combined with the body portion, or the elastic element is integrally molded with the object.

In the foregoing limiting structure, the body portion includes an arrangement portion, the fastening portion or the elastic element passes through the arrangement portion to be arranged at a placement portion of the body portion, and is stopped and limited by the stop portion, or the fastening portion or the elastic element passes the arrangement portion to be arranged on a placement portion of the body portion and is further configured to be stopped and limited by the stop portion.

In the foregoing limiting structure, the stop portion includes an arrangement portion, the fastening portion or the elastic element passes through the arrangement portion to be arranged at a placement portion of the stop portion, and is stopped and limited by the body portion, or the fastening portion or the elastic element passes the arrangement portion to be arranged on a placement portion of the stop portion and is further configured to be stopped and limited by the body portion.

In the foregoing limiting structure, the body portion includes an arrangement portion, the fastening portion or the elastic element passes through the arrangement portion to be arranged at a placement portion of the body portion, is configured for a tool to be combined with the fastening portion or the elastic element at the placement portion, and is configured to be stopped and limited by the stop portion.

In the foregoing limiting structure, the limiting portion includes a wide-hole portion and an entry portion that are in communication, or the limiting portion includes a wide-hole portion, an entry portion, and another wide-hole portion that are in communication, or the fastening portion is located at a lower position of the wide-hole portion for limiting, or the fastening portion is located at an upper position of the entry portion for limiting.

In the foregoing limiting structure, the body portion includes an arrangement portion, the fastening portion or the elastic element passes through the arrangement portion to be arranged at a placement portion of the body portion for placement, combination, or limiting, or the stop portion includes an arrangement portion, or the fastening portion or the elastic element passes through the arrangement portion to be arranged at a placement portion of the stop portion for placement, combination, or limiting.

In the foregoing limiting structure, a first anti-rotation portion is arranged on the stop portion, a second anti-rotation portion is arranged on the body portion, and the first anti-rotation portion and the second anti-rotation portion are configured to prevent rotation of the stop portion and the body portion.

In the foregoing limiting structure, the limiting portion is a through hole, a hole, a groove, a concave portion, or a convex portion smaller than the fastening portion.

In the foregoing limiting structure, the limiting portion is a hole portion, a groove portion, a convex portion, a concave portion, a step portion, an annular portion, or an annular groove portion.

In the foregoing limiting structure, the fastening portion is integrally molded with the body portion, and the fastening portion is configured to be engaged with another object.

In the foregoing limiting structure, the fastening portion is an externally threaded body, a columnar body, an outer fastening body, an inner fastening body, an internally threaded body, an elastic fastening body, a convex fastening body, a spherical body, a block body, a convex body, a concave body, a metal body, a plastic body, or an elastic element, or the stop portion includes a guide portion, or the guide portion is an inclined surface, an arc surface, or a stepped surface, or the guide portion is configured to allow the fastening portion to roll into, fall into, drop into, or move into a placement portion.

In the foregoing limiting structure, the body portion or the stop portion includes another fastening portion, where the another fastening portion is an externally threaded body, a columnar body, an outer fastening body, an inner fastening body, an internally threaded body, an elastic fastening body, a convex fastening body, a spherical body, or an elastic element.

In the foregoing limiting structure, the body portion includes an arrangement portion, the fastening portion passes through the arrangement portion to reach a placement portion of the body portion, and then, the stop portion limits the fastening portion at the body portion.

In the foregoing limiting structure, the stop portion is moved to control movement of the fastening portion, or the fastening portion is engaged with an object.

In the foregoing limiting structure, a second anti-rotation portion is arranged on the body portion, and the second anti-rotation portion prevents rotation of the object, and is configured to limit a direction or a position of another object with which the fastening portion is engaged; or another guide portion is arranged on the body portion, and the another guide portion is configured to guide the body portion to enter the another object; or a corresponding guide portion is arranged on the another object, and the corresponding guide portion is configured to guide the body portion to enter the another object.

In the foregoing limiting structure, a second anti-rotation portion is arranged on the body portion, and the second anti-rotation portion prevents rotation of the object, and is configured to limit a direction or a position of another object with which the fastening portion is engaged, where a catch portion is arranged on the another object, and the catch portion is configured to be engaged with the fastening portion, or the catch portion is riveted to, expansion-connected to, locked to, welded to, or engaged with the another object, or the catch portion is integrally molded with the another object, or another guide portion is arranged on the body portion, and the another guide portion is configured to guide the body portion to enter the catch portion; or a corresponding guide portion is arranged on the catch portion, and the corresponding guide portion is configured to guide the body portion to enter, or the another guide portion or the corresponding guide portion is an inclined surface, a curved surface, an arc surface, a stepped surface, or a flat surface.

In the foregoing limiting structure, the body portion includes an operated portion, the stop portion includes an operating portion, and the operating portion is configured to operate the operated portion, or the operated portion is configured to operate another fastening portion to engage with or lock into the object, or the operated portion or the operating portion is polygonal, hexagonal, multi-angled, rectangular, cross-shaped, non-circular, a convex portion, a concave portion, or an anti-rotation structure.

In the foregoing limiting structure, the stop portion includes a non-operating portion, and the operated portion enters the non-operating portion after leaving a range of the operating portion, or the non-operating portion is located above or below the operating portion.

In the foregoing limiting structure, the operating portion is connected to the stop portion, or the operating portion is configured to be riveted to or engaged with the stop portion, or the stop portion includes a material entry portion, and is configured to apply an external force to press a material of the stop portion to enter the material entry portion for connection, or the operating portion includes a fifth anti-rotation portion, where the fifth anti-rotation portion is configured to prevent rotation of the stop portion, or the fifth anti-rotation portion is serrations or a flat surface.

In the foregoing limiting structure, the fifth anti-rotation portion defines a direction of a limiting portion of the operating portion corresponding to the stop portion or a direction of the placement portion of the body portion, and is configured to limit the fastening portion such that the fastening portion corresponds to the limiting portion when the operated portion enters the operating portion.

In the foregoing limiting structure, the stop portion includes an operating portion, where a rotatable portion larger than the operating portion is provided below the operating portion, and configured to enable the operated portion to rotate at the rotatable portion.

In the foregoing limiting structure, the body portion includes a tool operating portion, or the tool operating portion is cross-shaped, rectangular, polygonal, non-circular, a convex portion, a concave portion, or an anti-rotation structure.

In the foregoing limiting structure, the stop portion includes a limiting portion or a placement portion, or the body portion includes a limiting portion or a placement portion, and the limiting portion or the placement portion is molded by injecting a liquid raw material inside a mold and then solidifying the liquid raw material; or a space including an arrangement portion inside the mold is configured for molding through solidification after injection of the liquid raw material; or a space including the limiting portion or the placement portion inside the mold is configured for molding through solidification after injection of the liquid raw material; or the limiting portion or the placement portion is located at an embedded piece, and the embedded piece is placed inside the mold and is configured for molding the body portion or the stop portion through solidification after injection of the liquid raw material; or the body portion or the stop portion has the limiting portion or the placement portion molded inside the mold; or the body portion or the stop portion is molded through solidification after being injected as a liquid raw material inside the mold; or the liquid raw material is a plastic material or a metal material.

In the foregoing limiting structure, the fastening portion is arranged between the body portion and the stop portion and abutted against by the elastic element, or the elastic element is arranged on the body portion or the stop portion, where the body portion or the stop portion is a flat surface, an arc surface, or a horizontal surface, or configured to allow the stop portion to stop or pause at any height or a specific height of the body portion steplessly by using a pushing force or a friction force from the elastic element during movement of the fastening portion.

In the foregoing limiting structure, the body portion includes another fastening portion or a connecting portion, configured to engage with or connect to the object, or the object is a printed circuit board, a heat-radiating apparatus, a chip, a metal body, or a housing, or the another fastening portion or the connecting portion is configured for lifting the object.

In the foregoing limiting structure, the body portion is an operating portion or operated portion configured to operate the body portion or another fastening portion.

The present disclosure provides another limiting method for a limiting structure, where the limiting structure includes a body portion, a stop portion, a fastening portion, and an elastic element. The stop portion is movably connected to the body portion. The fastening portion is connected to the body portion or an object. One end of the elastic element abuts against the body portion or the object, and an other end of the elastic element abuts against the stop portion or the fastening portion. The elastic element is configured to raise or spring up the stop portion. The fastening portion is configured to perform snap-locking, limiting, or engagement at a compressed position, a non-spring-up position, a low position, a high position, a raised position, or a non-raised position of the stop portion. The fastening portion is connected to the body portion or is integrally molded with the body portion, or the elastic element is connected to the body portion or the fastening portion, or the elastic element is integrally molded with the body portion or the fastening portion, or the body portion is configured to be riveted to, expansion-connected to, welded to, locked to, or engaged with the body portion, or the body portion is integrally molded with the object, or the fastening portion is connected to the body portion or is integrally molded with the body portion, or the elastic element is connected to the body portion or the fastening portion, or the elastic element is integrally molded with the body portion or the fastening portion, or the fastening portion is combined with the body portion, or the fastening portion is integrally molded with the object, or the elastic element is combined with the body portion, or the elastic element is integrally molded with the object.

The present disclosure provides another limiting method for a limiting structure, where the limiting structure includes a body portion, a stop portion, a fastening portion, and an elastic element. The stop portion is movably connected to the body portion. The fastening portion is arranged at the body portion, the stop portion, or an object. One end of the elastic element abuts against the body portion, the stop portion, or the object, and an other end of the elastic element abuts against the stop portion, the body portion, or the fastening portion. Alternatively, the elastic element is configured to raise or spring up the stop portion. The fastening portion is configured to perform snap-locking or limiting at a compressed position, a non-spring-up position, a low position, a high position, a raised position, or a non-raised position of the stop portion, or the elastic element is configured to raise or spring up the stop portion, for the fastening portion to perform snap-locking, limiting, engagement, or squeezing at a compressed position, a non-spring-up position, a low position, a high position, a raised position, or a non-raised position of the stop portion. The body portion or the stop portion includes an arrangement portion, where the arrangement portion is configured to allow the fastening portion or the elastic element to pass through, for the fastening portion or the elastic element to reach a placement portion for arrangement; or the body portion or the stop portion includes an arrangement portion, where the arrangement portion is configured to allow the fastening portion or the elastic element to pass through in a free-fall manner, for the fastening portion or the elastic element to reach a placement portion for arrangement; or the body portion or the stop portion includes an arrangement portion, and is configured to allow a tool to pass the fastening portion or the elastic element through the arrangement portion, for the fastening portion or the elastic element to reach a placement portion for arrangement; or the stop portion includes an arrangement portion, or the fastening portion or the elastic element passes through the arrangement portion to be arranged at a placement portion of the stop portion, and is stopped and limited by the body portion; or the body portion includes an arrangement portion, or the fastening portion or the elastic element passes the arrangement portion to be arranged on a placement portion of the body portion for placement, combination, or limiting; or the body portion includes an arrangement portion, the fastening portion or the elastic element passes through the arrangement portion to be arranged at a placement portion of the body portion, and is stopped and limited by the stop portion, or the fastening portion or the elastic element passes the arrangement portion to be arranged on a placement portion of the body portion and is further configured to be stopped and limited by the stop portion; or the stop portion includes an arrangement portion, the fastening portion or the elastic element passes through the arrangement portion to be arranged at a placement portion of the stop portion, and is stopped and limited by the body portion, or the fastening portion or the elastic element passes the arrangement portion to be arranged on a placement portion of the stop portion and is further configured to be stopped and limited by the body portion.

In this way, according to the limiting structure of the present disclosure, when the fastening portion engages with the stop portion, the elastic element can be compressed, and the stop portion can be limited to a non-raised position. When the fastening portion disengages from the stop portion, the elastic element can spring up the stop portion to a raised position, so that a force can be applied to the stop portion to move at least one object, thereby achieving an objective of easy operation and use.

### BRIEF DESCRIPTION OF THE DRAWINGS

FIG. 1 is a schematic diagram of an appearance according to a first embodiment of the present disclosure.

FIG. 2 is a schematic exploded view of a first embodiment of the present disclosure.

FIG. 3 is a schematic diagram of a use state according to a first embodiment of the present disclosure.

FIG. 4 is a schematic diagram of a use state according to a second embodiment of the present disclosure.

FIG. 5 is a schematic diagram of another form of a fastening portion in a third embodiment of the present disclosure.

FIG. 6 is a schematic diagram of a use state according to a third embodiment of the present disclosure.

FIG. 7 is a schematic diagram 1 of a use state according to a fourth embodiment of the present disclosure.

FIG. 8 is a schematic diagram 2 of a use state according to a fourth embodiment of the present disclosure.

FIG. 9 is a schematic diagram of a use state according to a fifth embodiment of the present disclosure.

FIG. 10 is a schematic diagram of a use state according to a sixth embodiment of the present disclosure.

FIG. 11 is a schematic diagram of a use state according to a seventh embodiment of the present disclosure.

FIG. 12 is a schematic diagram of a use state according to an eighth embodiment of the present disclosure.

FIG. 13 is a schematic diagram of a use state according to a ninth embodiment of the present disclosure.

FIG. 14 is a schematic diagram of a use state according to a tenth embodiment of the present disclosure.

FIG. 15 is a schematic diagram of a use state according to an eleventh embodiment of the present disclosure.

FIG. 16 is a schematic diagram of a use state according to a twelfth embodiment of the present disclosure.

FIG. 17 is a schematic diagram 1 of a use state according to a thirteenth embodiment of the present disclosure.

FIG. 18 is a schematic diagram 2 of a use state according to a thirteenth embodiment of the present disclosure.

FIG. 19 is a schematic diagram 1 of a use state according to a fourteenth embodiment of the present disclosure.

FIG. 20 is a schematic diagram 2 of a use state according to a fourteenth embodiment of the present disclosure.

FIG. 21 is a schematic diagram of a use state according to a fifteenth embodiment of the present disclosure.

FIG. 22 is a schematic diagram of a use state according to a sixteenth embodiment of the present disclosure.

FIG. 23 is a schematic diagram of a use state according to a seventeenth embodiment of the present disclosure.

FIG. 24 is a schematic diagram 1 of a use state according to an eighteenth embodiment of the present disclosure.

FIG. 25 is a schematic diagram 2 of a use state according to an eighteenth embodiment of the present disclosure.

FIG. 26 is a schematic diagram of a use state according to a nineteenth embodiment of the present disclosure.

FIG. 27 is a schematic diagram of a use state according to a twentieth embodiment of the present disclosure.

FIG. 28 is a schematic diagram of a use state according to a twenty-first embodiment of the present disclosure.

FIG. 29 is a schematic diagram of a use state according to a twenty-second embodiment of the present disclosure.

FIG. 30 is a schematic diagram of different forms of a fastening portion according to the present disclosure.

FIG. 31 is a schematic diagram of a use state according to a twenty-third embodiment of the present disclosure.

FIG. 32 is a schematic diagram of a use state according to a twenty-fourth embodiment of the present disclosure.

FIG. 33 is a schematic diagram 1 of a use state according to a twenty-fifth embodiment of the present disclosure.

FIG. 34 is a schematic diagram 2 of a use state according to a twenty-fifth embodiment of the present disclosure.

FIG. 35 is a schematic diagram of a use state according to a twenty-sixth embodiment of the present disclosure.

FIG. 36 is a schematic diagram of a use state according to a twenty-seventh embodiment of the present disclosure.

FIG. 37 is a schematic diagram of a use state according to a twenty-eighth embodiment of the present disclosure.

FIG. 38 is a schematic diagram 1 of an injection molding state according to the present disclosure.

FIG. 39 is a schematic diagram 2 of an injection molding state according to the present disclosure.

FIG. 40 is a schematic diagram 3 of an injection molding state according to the present disclosure.

FIG. 41 is a schematic diagram of a use state according to a twenty-ninth embodiment of the present disclosure.

FIG. 42 is a schematic diagram of a use state according to a thirtieth embodiment of the present disclosure.

FIG. 43 is a schematic diagram of a use state according to a thirty-first embodiment of the present disclosure.

FIG. 44 is a schematic diagram of a use state according to a thirty-second embodiment of the present disclosure.

FIG. 45 is a schematic diagram of a use state according to a thirty-third embodiment of the present disclosure.

FIG. 46 is a schematic diagram of a use state according to a thirty-fourth embodiment of the present disclosure.

FIG. 47 is a schematic diagram of a use state according to a thirty-fifth embodiment of the present disclosure.

FIG. 48 is a schematic diagram of a use state according to a thirty-sixth embodiment of the present disclosure.

FIG. 49 is a schematic diagram of a use state according to a thirty-seventh embodiment of the present disclosure.

FIG. 50 is a schematic diagram of a use state according to a thirty-eighth embodiment of the present disclosure.

FIG. 51 is a schematic diagram of a use state according to a thirty-ninth embodiment of the present disclosure.

FIG. 52 is a schematic diagram of a use state according to a fortieth embodiment of the present disclosure.

### DETAILED DESCRIPTION OF THE INVENTION

To fully understand the objectives, features, functions of the present disclosure, the present disclosure is described in detail by using the following specific embodiments and with reference to the accompanying drawings. The description is as follows.

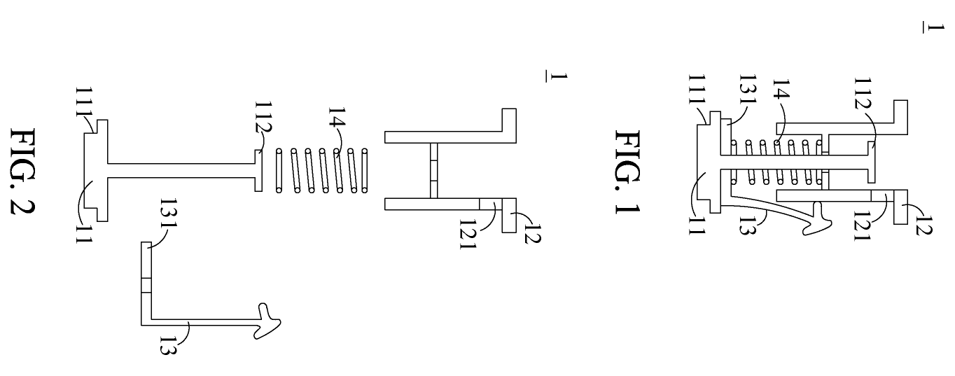

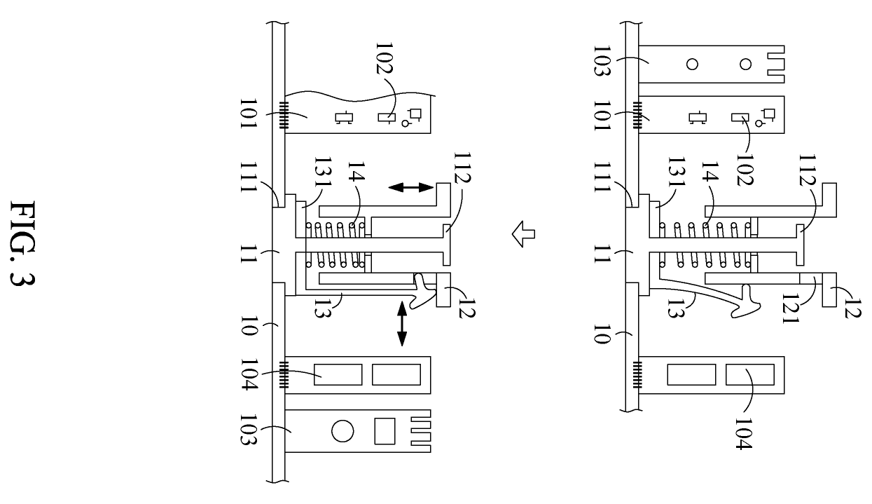

Referring to FIGS. 1-3, as shown in the figures, the present disclosure provides a limiting structure 1. The limiting structure 1 includes a body portion 11, a stop portion 12, a fastening portion 13, and an elastic element 14.

The body portion 11 is assembled on an object 10.

The stop portion 12 is movably connected to the body portion 11.

The fastening portion 13 is connected to the body portion 11 (or the fastening portion 13 is connected to an object 10, or the fastening portion 13 is integrally molded with the body portion 11, or the fastening portion 13 is arranged at the stop portion 12). The fastening portion 13 may be an elastic body or an object having an elastic element.

One end of the elastic element 14 abuts against the body portion 11 (or the stop portion 12 or the object 10), and an other end of the elastic element 14 abuts against the stop portion 12 (or the body portion 11 or the fastening portion 13). In this embodiment, the other end of the elastic element 14 abuts against the fastening portion 13, and the elastic element 14 is configured to raise or spring up the stop portion 12. In addition, the elastic element 14 may be a spring, a torsion spring, or an elastic columnar body. The fastening portion 13 is configured to perform snap-locking, limiting, engagement, or squeezing at a compressed position, a non-spring-up position, a low position, a high position, a raised position, or a non-raised position of the stop portion 12 (or the body portion 11).

In use, the limiting structure 1 may be assembled on the object 10 through the body portion 11. The object 10 may be a circuit board provided with a metal body, a plastic body, a connector 101, a chip 102, a heat-dissipating body 103, a memory 104, a heat-generating body, or a conductive body, or the object 10 may be a circuit board, a metal body, a plastic body, a connector 101, a chip 102, a heat-dissipating body 103, a memory 104, a heat-generating body, or a conductive body, or the limiting structure 1 may be a handle, a fastening body, a telescopic body, or a lifting body.

Moreover, when a needed limiting method is performed by the limiting structure 1, the stop portion 12 can be engaged with or disengaged from by using the fastening portion 13. During engagement, the stop portion 12 may be engaged by the fastening portion 13, and the elastic element 14 is compressed by the stop portion 12, so that in cooperation with snap-locking, limiting, engagement, or squeezing by the fastening portion 13, the stop portion 12 is at a non-spring-up position or a non-raised position, that is, the stop portion 12 is lowered to a position not higher than the body portion 11, for accommodation of the stop portion 12 when not in use.

However, when the fastening portion 13 leaves the stop portion 12 for disengagement, the fastening portion 13 is located at a non-snap-locked position or a non-limit position, and the elastic element 14 pushes and raises or springs up the stop portion 12 due to elastic release, so that the elastic element 14 raises or springs up the stop portion 12 to a spring-up position or a raised position, thereby applying a force to the stop portion 12 to move at least one object 10.

Based on the description of the foregoing embodiment, the limiting structure 1 of the present disclosure can assemble the body portion 11 on the object 10. When the fastening portion 13 engages with the stop portion 12, the elastic element 14 can be compressed, and the stop portion 12 can be limited to a non-raised position. When the fastening portion 13 disengages from the stop portion 12, the elastic element 14 can spring up the stop portion 12 to a raised position, so that a force can be applied to the stop portion 12 to move at least one object 10, thereby achieving an effect of easy operation and use.

In addition to the foregoing embodiment, in an embodiment of the present disclosure, the embodiment differs from the foregoing embodiment in that a connecting portion 111 is arranged on the body portion 11 of the limiting structure 1, so that the body portion 11 is connected to the object 10 by the connecting portion 111 by expansion, welding, locking, clamping, or bonding. In this way, the body portion 11 is firmly arranged on the object 10 by using the connecting portion 111, to help the stop portion 12, the fastening portion 13, and the elastic element 14 perform related force-applying operations.

In addition to the foregoing embodiment, in an embodiment of the present disclosure, the embodiment differs from the foregoing embodiment in that a limiting portion 112 is arranged on the body portion 11, and the limiting portion 112 is configured to movably limit the stop portion 12, so that the stop portion 12 is movably connected to the body portion 11, and by using the limiting portion 112, the stop portion 12 is prevented from being separated from the body portion 11.

In addition to the foregoing embodiment, in an embodiment of the present disclosure, the embodiment differs from the foregoing embodiment in that the fastening portion 13 may be an elastic body integrally injection molded from plastic, and the fastening portion 13 is provided with an insertion portion 131, and the fastening portion 13 is located on a side of the insertion portion 131, so that the fastening portion 13 is connected to the body portion 11 by using the insertion portion 131, and the fastening portion 13 engages with or disengages from the stop portion 12 by using elasticity of the fastening portion 13.

In addition to the foregoing embodiment, in an embodiment of the present disclosure, the embodiment differs from the foregoing embodiment in that the stop portion 12 may be operated to raise the stop portion 12 by more than 3 mm, so that the stop portion 12 lifts or operates the object 10, or the stop portion is higher than a height of a metal body, a plastic body, a main board, a connector 101, a chip 102, a heat-dissipating body 103, a memory 104, a heat-generating body, a conductive body, or various elements arranged on the object 10.

In addition to the foregoing embodiment, in an embodiment of the present disclosure, the embodiment differs from the foregoing embodiment in that a limiting portion 121 is arranged on the stop portion 12, and the fastening portion 13 may be engaged with the limiting portion 121 for limiting. In this way, during engagement, cooperation from the limiting portion 121 can be used to engage the fastening portion 13 firmly with the stop portion 12.

In addition to the foregoing embodiment, in an embodiment of the present disclosure, the embodiment differs from the foregoing embodiment in that the elastic element 14 is connected to the body portion 11 (or the fastening portion 13), or the elastic element 14 is integrally molded with the body portion 11 (or the fastening portion 13), so that the present disclosure can meet an actual application requirement.

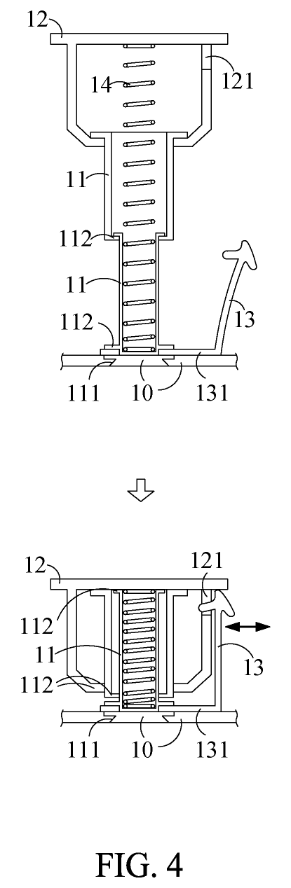

Referring to FIG. 4, as shown in the figure, in addition to the foregoing embodiment, in an embodiment of the present disclosure, the embodiment differs from the foregoing embodiment in that two or more body portions 11 are provided. However, in the present disclosure, using two body portions 11 as an embodiment, the body portions 11 and the stop portion 12 can be combined in a sleeved manner into a telescopic form, and two ends of the elastic element 14 respectively abut against the body portion 11 and the stop portion 12.

Based on the foregoing embodiment, during engagement, the body portions 11 and the stop part 12 may be stacked on top of each other (for example, stacked as inner and outer layers). In addition, the stop portion 12 is engaged by the fastening portion 13, and the elastic element 14 is compressed by the stop portion 12, so that in cooperation with snap-locking, limiting, engagement, or squeezing by the fastening portion 13, the stop portion 12 is at a non-spring-up position or a non-raised position, for accommodation of the body portions 11 and the stop portion 12 when not in use.

However, when the fastening portion 13 leaves the stop portion 12 for disengagement, the fastening portion 13 is located at a non-snap-locked position or a non-limit position, and the elastic element 14 pushes and raises or springs up at least one of the body portions 11 and the stop portion 12 due to elastic release, so that the elastic element 14 simultaneously raises or springs up the at least one of the body portions 11 and the stop portion 12 to a spring-up position or a raised position, thereby applying a force to the stop portion 12 to move at least one object 10.

As described above, when the fastening portion 13 engages with the body portions 11 and the stop portion 12, the elastic element 14 can be compressed, and the body portions 11 and the stop portion 12 can be limited to a non-raised position. When the fastening portion 13 disengages from the stop portion 12, the elastic element 14 can spring up one of the body portion 11 and the stop portion 12 to a raised position, so that a force can be applied to the stop portion 12 to move at least one object 10, thereby achieving an effect of easy operation and use.

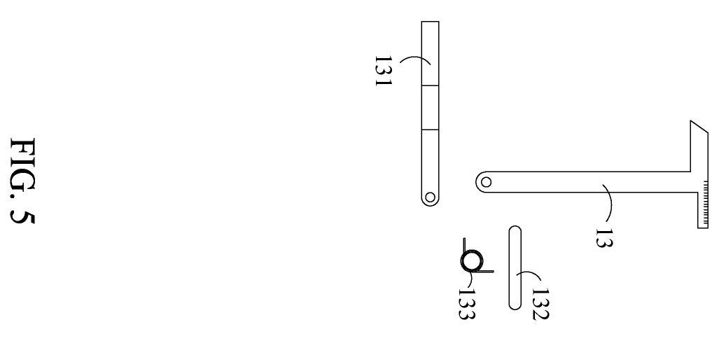

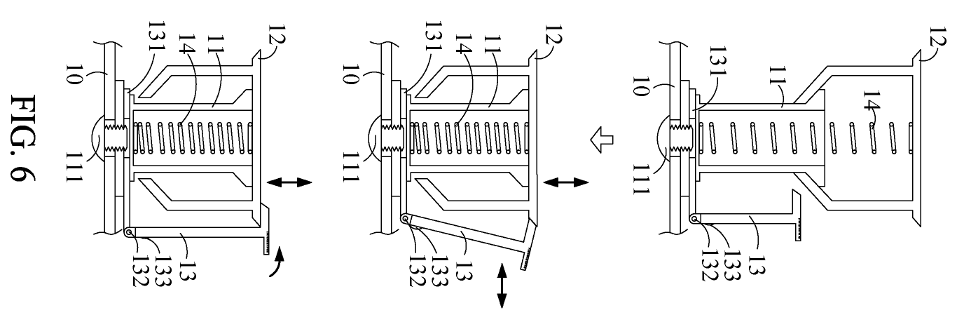

Referring to FIGS. 5 and 6, as shown in the figures, in addition to the foregoing embodiment, in an embodiment of the present disclosure, the embodiment differs from the foregoing embodiment in that a fastening portion 13 may be molded in a combined manner. In the present disclosure, the fastening portion 13 may be molded by combining an insertion portion 131, a combination portion 132, and an elastic piece 133, where the fastening portion 13 and the insertion portion 131 are combined by using the combination portion 132. The elastic piece 133 may be a torsion spring and is sleeved on the combination portion 132, and two ends of the elastic piece 133 are respectively abutted against the fastening portion 13 and the insertion portion 131, so that the elastic piece 133 applies elasticity to the fastening portion 13.

Based on the foregoing embodiment, when the fastening portion 13 performs engagement, elasticity may be applied to the fastening portion 13 through elastic release of elastic release of the elastic piece 133, so that the fastening portion 13 is firmly engaged with the stop portion 12. Moreover, when a force is applied to the fastening portion 13 for engagement or disengagement, the fastening portion 13 may be moved horizontally (or rotatably) on a side of the insertion portion 131 by using the combination portion 132 as an axis and compress the elastic piece 133 at the same time. After the fastening portion 13 is disengaged from the stop portion 12, elasticity may be applied to the fastening portion 13 through elastic release of the elastic piece 133, to return the fastening portion 13, to help the fastening portion 13 perform an engagement operation again, thereby achieving an effect of easy operation and use.

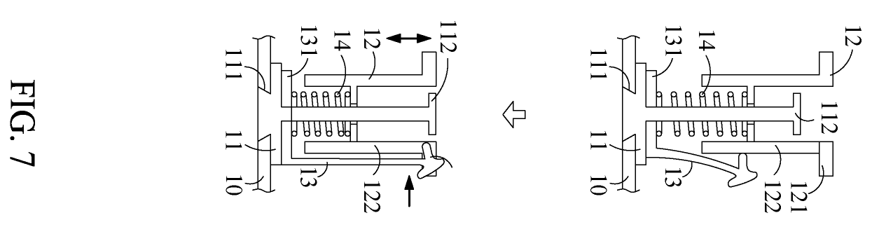

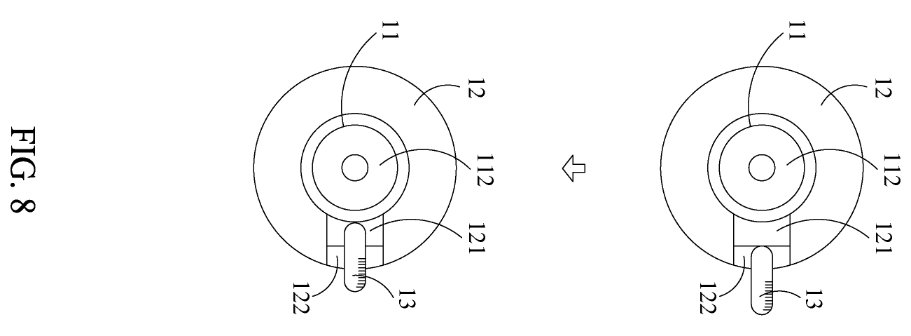

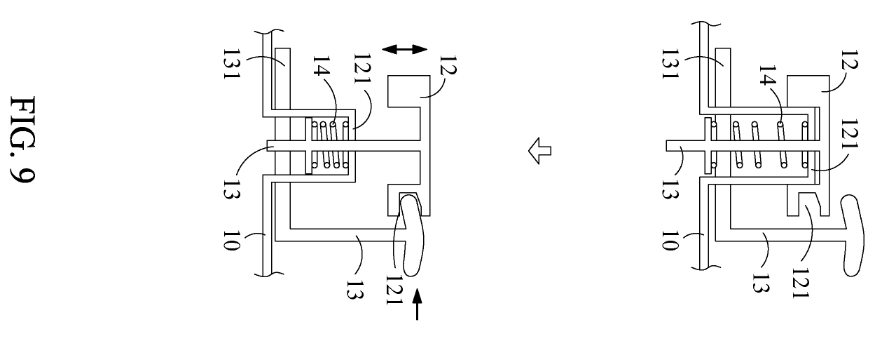

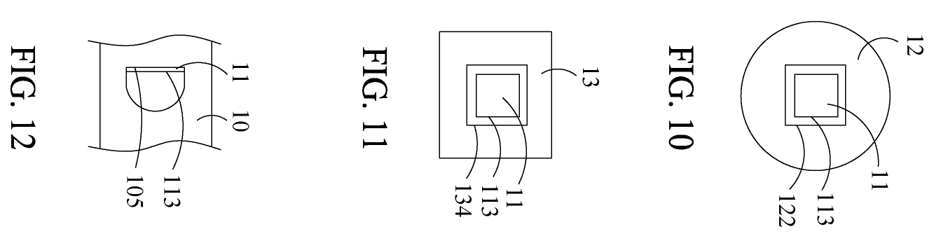

Referring to FIGS. 7-12, as shown in the figures, in addition to the foregoing embodiment, in an embodiment of the present disclosure, the embodiment differs from the foregoing embodiment in that the fastening portion 13 is configured to be horizontally (or rotatably) engaged with a limiting portion 121 of the stop portion 12 for limiting. In this way, during engagement, cooperation from the limiting portion 121 can be used to engage the fastening portion 13 firmly with the stop portion 12.

In addition to the foregoing embodiment, in an embodiment of the present disclosure, the embodiment differs from the foregoing embodiment in that there may be two fastening portions 13, one of the fastening portions 13 is horizontally (or in a rotation direction) engaged with the limiting portion 121 of the stop portion 12, and the other of the fastening portions 13 may be integrally molded with the body portion 11 and engaged with another object. Therefore, the present disclosure can achieve an effect of easy operation and use according to an actual application requirement.

In addition to the foregoing embodiment, in an embodiment of the present disclosure, the embodiment differs from the foregoing embodiment in that a first anti-rotation portion 122 for preventing rotation of the fastening portion 13 is arranged on the stop portion 12, and the first anti-rotation portion 122 and a limiting portion 112 of the body portion 11 are located in a same axial direction, and are configured to first prevent rotation and then perform limiting.

In addition to the foregoing embodiment, in an embodiment of the present disclosure, the embodiment differs from the foregoing embodiment in that in addition to the first anti-rotation portion 122 arranged on the stop portion 12, a second anti-rotation portion 113 is arranged on the body portion 11, a third anti-rotation portion 134 is arranged on the fastening portion 13, and a fourth anti-rotation portion 105 is arranged on the object 10, where the first anti-rotation portion 122, the second anti-rotation portion 113, the third anti-rotation portion 134, and the fourth anti-rotation portion 105 are configured to limit a direction, a position, or an orientation, so that the limiting structure 1 is firmly arranged on the object 10 and provides stability for the stop portion 12, the fastening portion 13, and the elastic element 14 to perform related force-applying operations.

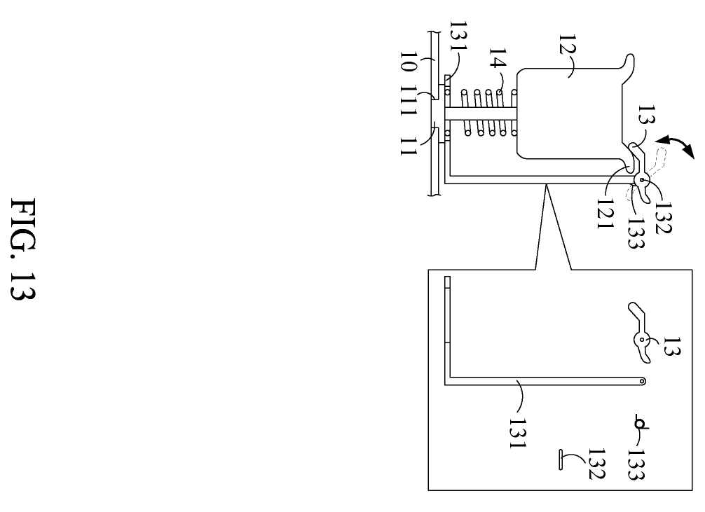

Referring to FIGS. 13-14, as shown in the figures, in addition to the foregoing embodiment, in an embodiment of the present disclosure, the embodiment differs from the foregoing embodiment in that the fastening portion 13 may be molded in a combined manner (as shown in FIG. 13) or integrally molded (as shown in FIG. 13), and the fastening portion 13 may be a fastening body that moves horizontally by more than 180 degrees. For example, the fastening portion 13 may be a barbed structure, and in cooperation with elasticity of the elastic piece 133 or the fastening portion 13, press down the stop portion 12 by applying a force, so that the fastening portion 13 is separated by using the elasticity of the elastic piece 133 or the fastening portion 13, thereby achieving an effect of easy operation and use.

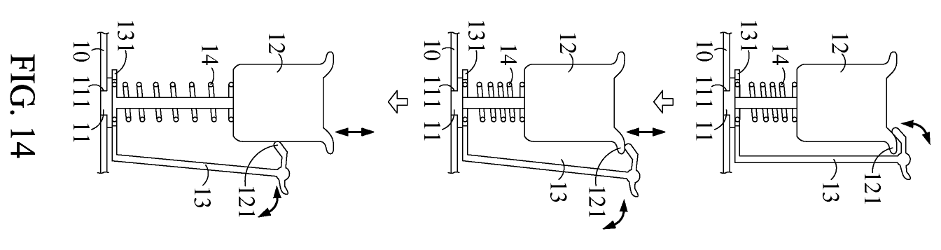

Referring to FIG. 15, as shown in the figure, in addition to the foregoing embodiment, in an embodiment of the present disclosure, the embodiment differs from the foregoing embodiment in that the fastening portion 13 is integrally molded with the object 10, and two limiting portions 121 are provided. One of the limiting portions 121 is located at an upper position, and the other of the limiting portions 121 is located at a lower position, to separately limit the fastening portion 13 to the lower position or the upper position by using the limiting portions 121. Therefore, the present disclosure can achieve an effect of easy operation and use according to an actual application requirement.

Referring to FIG. 16, as shown in the figure, in addition to the foregoing embodiment, in an embodiment of the present disclosure, the embodiment differs from the foregoing embodiment in that the stop portion 12 is elastic and is integrally molded with the fastening portion 13 (or molded in a combined manner), so that the stop portion 12 is moved to separately limit the fastening portion 13 to a lower position or an upper position by using the limiting portions 121 arranged in the body portion 11. Therefore, the present disclosure can achieve an effect of easy operation and use according to an actual application requirement.

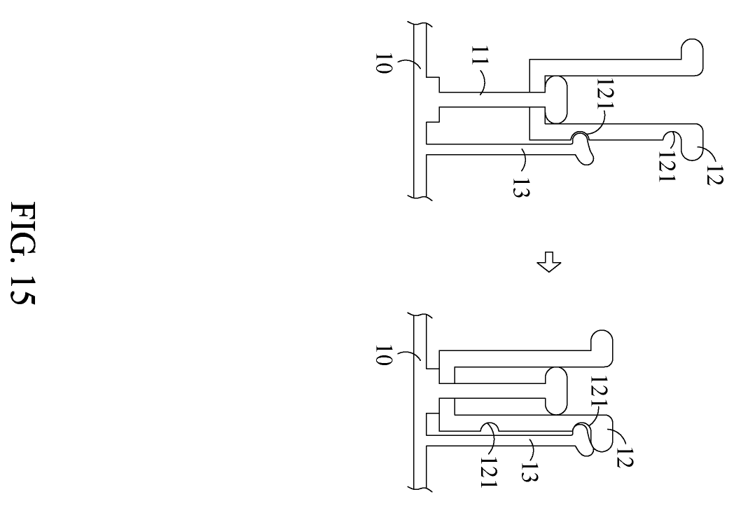

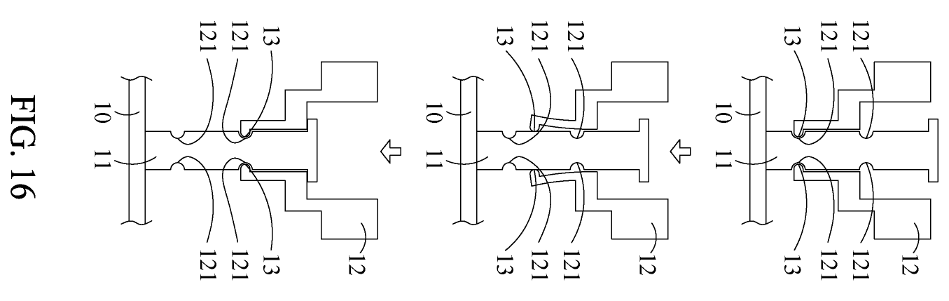

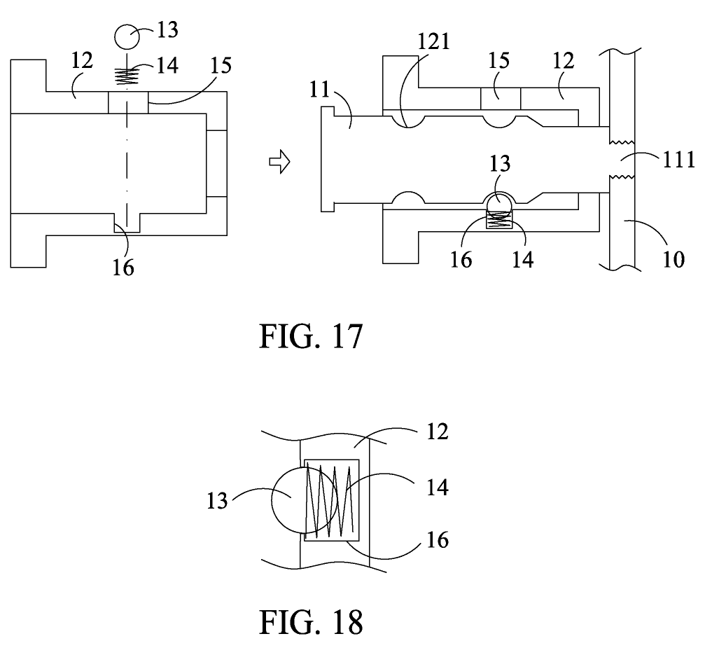

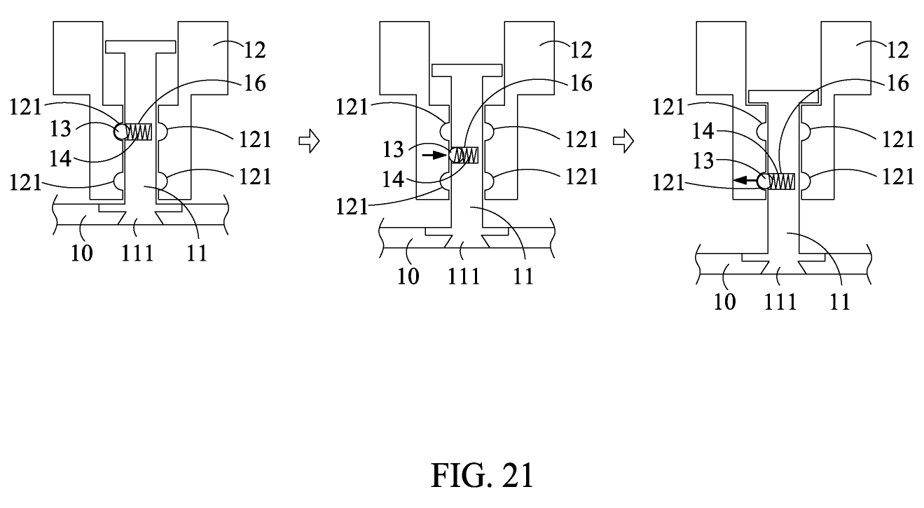

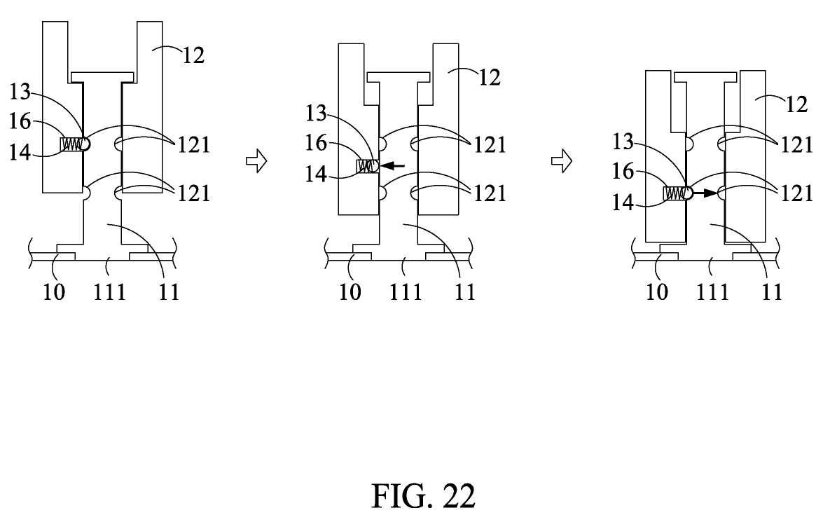

Referring to FIGS. 17-22, as shown in the figures, in addition to the foregoing embodiment, in an embodiment of the present disclosure, the embodiment differs from the foregoing embodiment in that the fastening portion 13 may be arranged on the body portion 11, and two limiting portions 121 are provided. One of the limiting portions 121 is located at an upper position, and the other of the limiting portions 121 is located at a lower position. In addition, the stop portion 12 (or the body portion 11) includes an arrangement portion 15, the fastening portion 13 or the elastic element 14 passes through the arrangement portion 15 to be arranged at a placement portion 16 of the stop portion 12, and is stopped and limited by the body portion 11 (as shown in FIGS. 17 and 18), so that the fastening portion 13 is separately limited to the lower position or the upper position by using the limiting portions 121 (as shown in FIGS. 21 and 22). Therefore, the present disclosure can achieve an effect of easy operation and use according to an actual application requirement.

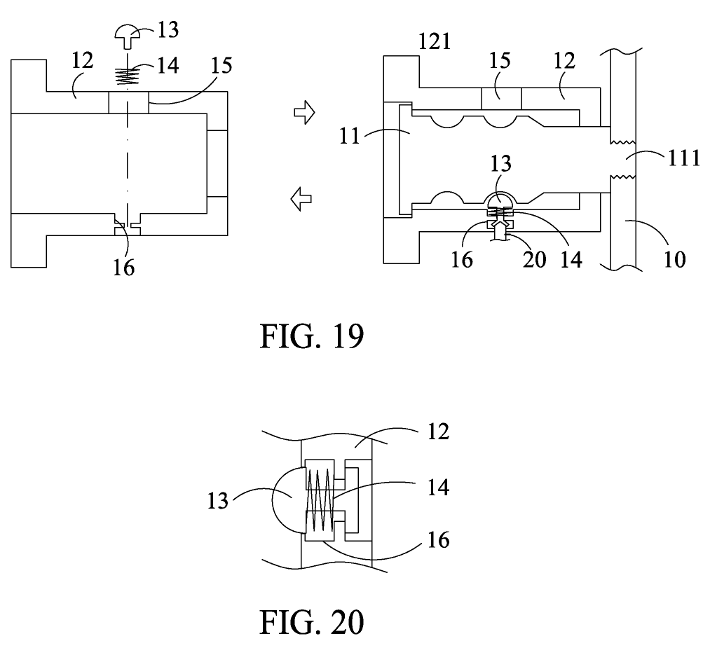

In addition to the foregoing embodiment, in an embodiment of the present disclosure, the embodiment differs from the foregoing embodiment in that during assembly, a tool 20 may be used to combine the fastening portion 13 and the elastic element 14 at the placement portion 16, and stop and limit them with the body portion 11 (as shown in FIGS. 19 and 20). Therefore, the present disclosure can achieve an effect of easy operation and use according to an actual application requirement.

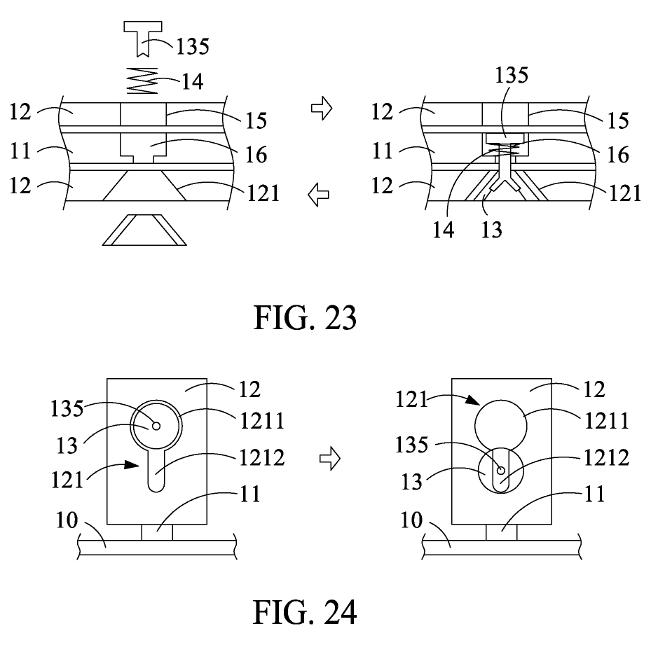

Referring to FIGS. 23-26, as shown in the figures, in addition to the foregoing embodiment, in an embodiment of the present disclosure, the embodiment differs from the foregoing embodiment in that the stop portion 12 (or the body portion 11) includes an arrangement portion 15, and the fastening portion 13 and the elastic element 14 pass through the arrangement portion 15 to be arranged at a placement portion 16 of the body portion 11 for placement, combination, or limiting. For example, in cooperation with a bar portion 135, the fastening portion 13 is combined with the elastic element 14 at the placement portion 16 (as shown in FIG. 23). Therefore, the present disclosure can achieve an effect of easy operation and use according to an actual application requirement.

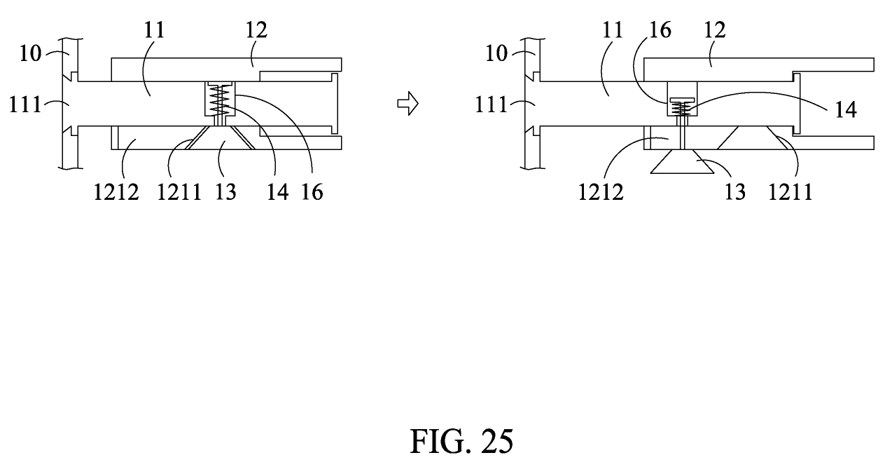

In addition to the foregoing embodiment, in an embodiment of the present disclosure, the embodiment differs from the foregoing embodiment in that the limiting portion 121 includes a wide-hole portion 1211 and an entry portion 1212 that are in communication, where the fastening portion 13 may be located at a lower position of the wide-hole portion 1211 for limiting, or the fastening portion 13 may be located at an upper position of the entry portion 1212 for limiting (as shown in FIGS. 24 and 25). Therefore, the present disclosure can achieve an effect of easy operation and use according to an actual application requirement.

In addition to the foregoing embodiment, in an embodiment of the present disclosure, the embodiment differs from the foregoing embodiment in that the limiting portion 121 includes a wide-hole portion 1211, an entry portion 1212, and another wide-hole portion 1213 that are in communication, where the fastening portion 13 may be located at a lower position of the wide-hole portion 1211 of the another wide-hole portion 1213 for limiting, or the fastening portion 13 may be located at an upper position of the entry portion 1212 for limiting (as shown in FIG. 26). Therefore, the present disclosure can achieve an effect of easy operation and use according to an actual application requirement.

Referring to FIGS. 27-28, as shown in the figures, in addition to the foregoing embodiment, in an embodiment of the present disclosure, the embodiment differs from the foregoing embodiment in that a first anti-rotation portion 122 is arranged on the stop portion 12, a second anti-rotation portion 113 is arranged on the body portion 11, and the first anti-rotation portion 122 and the second anti-rotation portion 113 are configured to prevent rotation of the stop portion 12 and the body portion 11. Therefore, the present disclosure can achieve an effect of easy operation and use according to an actual application requirement.

In addition to the foregoing embodiment, in an embodiment of the present disclosure, the embodiment differs from the foregoing embodiment in that the limiting portion 121 may be a through hole, a hole, a groove, a concave portion, or a convex portion smaller than the fastening portion 13; or the limiting portion 121 may be a hole portion, a groove portion, a convex portion, a concave portion, a step portion, an annular portion, or an annular groove portion, to enable the limiting portion 121 to stop the fastening portion 13.

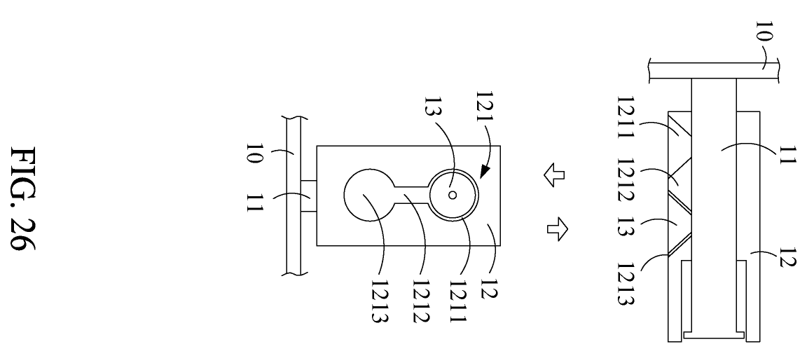

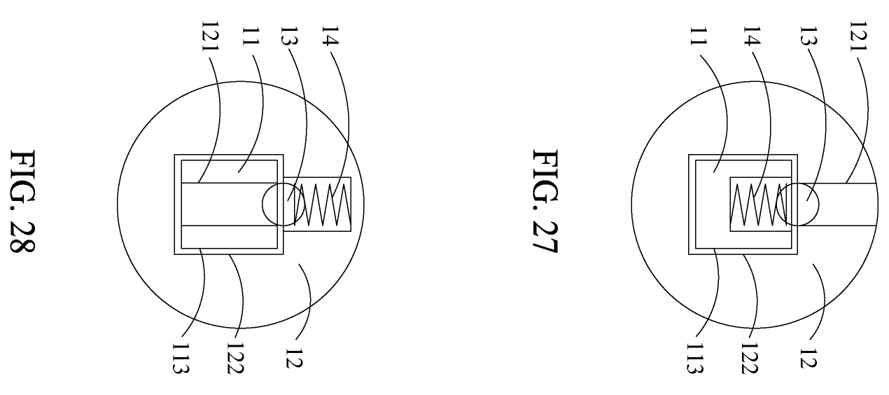

Referring to FIGS. 29 and 30, as shown in the figures, in addition to the foregoing embodiment, in an embodiment of the present disclosure, the embodiment differs from the foregoing embodiment in that the fastening portion 13 is integrally molded with the body portion 11, and the fastening portion 13 may be configured to be engaged with another object 30. Therefore, the present disclosure can achieve an effect of easy operation and use according to an actual application requirement.

In addition to the foregoing embodiment, in an embodiment of the present disclosure, the embodiment differs from the foregoing embodiment in that the fastening portion 13 may be an externally threaded body (for example, a part a in FIG. 30), a columnar body (for example, a part b in FIG. 30), an outer fastening body (for example, a part c in FIG. 30), an inner fastening body (for example, a part d in FIG. 30), an internally threaded body (for example, a part e in FIG. 30), an elastic fastening body (for example, a part f in FIG. 30), a convex fastening body, a spherical body, a block body, a convex body, a concave body, a metal body, a plastic body, or an elastic element. Therefore, the fastening portion 13 can meet an operation requirement in actual application.

Referring to FIG. 31, as shown in the figure, in addition to the foregoing embodiment, in an embodiment of the present disclosure, the embodiment differs from the foregoing embodiment in that the body portion 11 or the stop portion 12 includes another fastening portion 17. In the present disclosure, using an example in which another fastening portion 17 is arranged on each of the body portion 11 and the stop portion 12, so that the another fastening portion 17 can be separately engaged with a to-be-engaged object. Therefore, the limiting structure 1 can meet an operation requirement in actual application.

In addition to the foregoing embodiment, in an embodiment of the present disclosure, the embodiment differs from the foregoing embodiment in that the another fastening portion 17 may be an externally threaded body, a columnar body, an outer fastening body, an inner fastening body, an internally threaded body, an elastic fastening body, a convex fastening body, a spherical body, a block body, a convex body, a concave body, a metal body, a plastic body, or an elastic element. Therefore, the another fastening portion 17 can meet an operation requirement in actual application.

In addition to the foregoing embodiment, in an embodiment of the present disclosure, the embodiment differs from the foregoing embodiment in that the body portion 11 (or the stop portion 12) includes an arrangement portion 15. The arrangement portion 15 is configured to allow the fastening portion 13 to pass through, for the fastening portion to reach the placement portion 16 for arrangement, and after the stop portion 12 is movably connected to the body portion 11, allow the fastening portion 13 to be limited by the limiting portion 121 Therefore, the fastening portion 13 can meet an operation requirement in actual application.

In addition to the foregoing embodiment, in an embodiment of the present disclosure, the embodiment differs from the foregoing embodiment in that the arrangement portion 15 is configured to allow the fastening portion 13 and the elastic element 14 to pass through in a free-fall manner, for the fastening portion 13 to reach the placement portion 16 for arrangement; and is configured to allow a tool (not shown in the figure) pass the fastening portion 13 and the elastic element 14 through the arrangement portion 15, for the fastening portion 13 and the elastic element 14 to reach the placement portion 16 for arrangement. Therefore, the fastening portion 13 can better meet requirements in actual assembly and application.

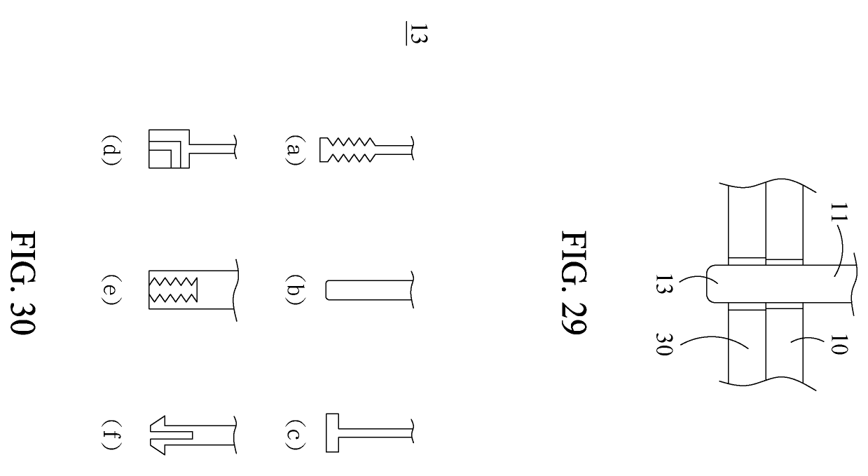

Referring to FIG. 32, as shown in the figure, in addition to the foregoing embodiment, in an embodiment of the present disclosure, the embodiment differs from the foregoing embodiment in that the fastening portion 13 passes through the arrangement portion 15 to reach the placement portion 16 of the body portion 11, and then, the fastening portion 13 is limited to the body portion 11 by the stop portion 12. The stop portion 12 may be moved to control movement of the fastening portion 13, for the fastening portion 13 to be engaged with the object 10. Therefore, the fastening portion 13 can better meet requirements in actual assembly and application.

In addition to the foregoing embodiment, in an embodiment of the present disclosure, the embodiment differs from the foregoing embodiment in that the stop portion 12 includes a guide portion 123. The guide portion 123 may be an inclined surface, an arc surface, or a stepped surface, so that the guide portion 123 is configured to allow the fastening portion 13 to smoothly roll into, fall into, drop into, or move into the placement portion 16, so that the fastening portion 13 is engaged with the object 10 or the another object 30. Therefore, the fastening portion 13 can better meet requirements in actual assembly and application.

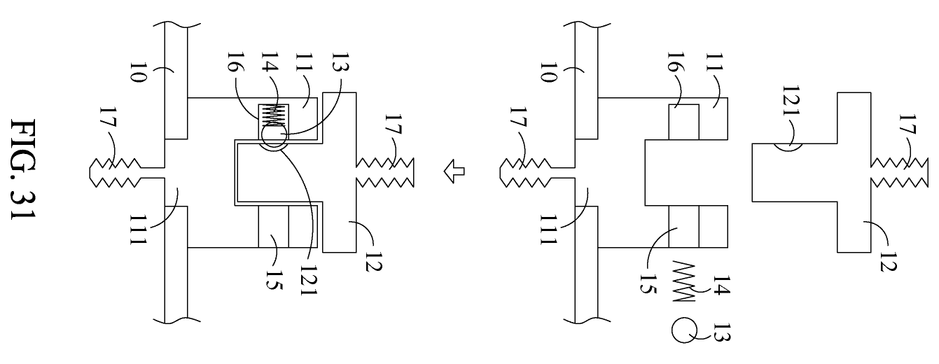

Referring to FIGS. 33 and 34, as shown in the figures, in addition to the foregoing embodiment, in an embodiment of the present disclosure, the embodiment differs from the foregoing embodiment in that a second anti-rotation portion 113 of the body portion 11 can prevent rotation of the object 10 and be configured to limit a direction or a position in which the fastening portion 13 is engaged with the another object 30. Another guide portion 114 is arranged on the body portion 11, and a corresponding guide portion 301 is arranged on the another object 30. In addition, the another guide portion 114 is configured to cooperate with the corresponding guide portion 301, to guide the body portion 11 to enter the another object 30. Therefore, the limiting structure 1 can better meet requirements in actual assembly and application.

In addition to the foregoing embodiment, in an embodiment of the present disclosure, the embodiment differs from the foregoing embodiment in that a catch portion 302 is arranged on the another object, and the catch portion 302 is configured to engage with the fastening portion 13, for the another guide portion 114 to guide the body portion 11 to enter the catch portion 302, where the corresponding guide portion 301 may be arranged on the catch portion 302, for the corresponding guide portion 301 to guide the body portion 11 to enter the catch portion 302. Therefore, the limiting structure 1 can better meet requirements in actual assembly and application.

In addition to the foregoing embodiment, in an embodiment of the present disclosure, the embodiment differs from the foregoing embodiment in that the catch portion 302 may be riveted to, expansion-connected to, locked to, welded to, or engaged with the another object 30, or the catch portion 302 is integrally molded with the another object 30, so that the catch portion 302 is firmly combined with the another object 30.

In addition to the foregoing embodiment, in an embodiment of the present disclosure, the embodiment differs from the foregoing embodiment in that the another guide portion 114 and the corresponding guide portion 301 may be inclined surfaces, curved surfaces, arc surfaces, stepped surfaces, or flat surfaces, so that the another guide portion 114 and the corresponding guide portion 301 can smoothly guide each other.

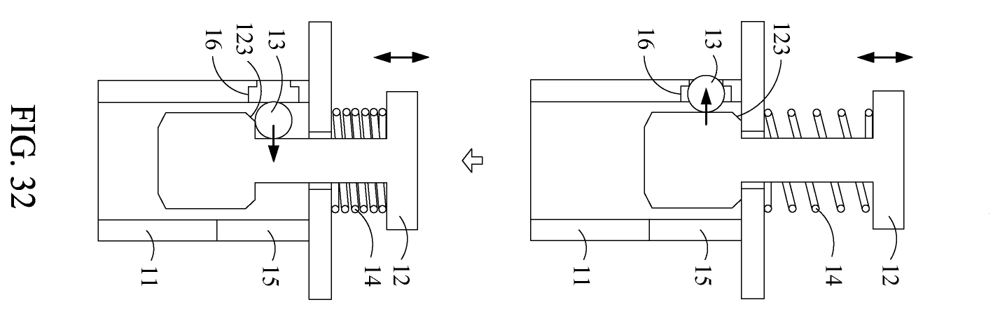

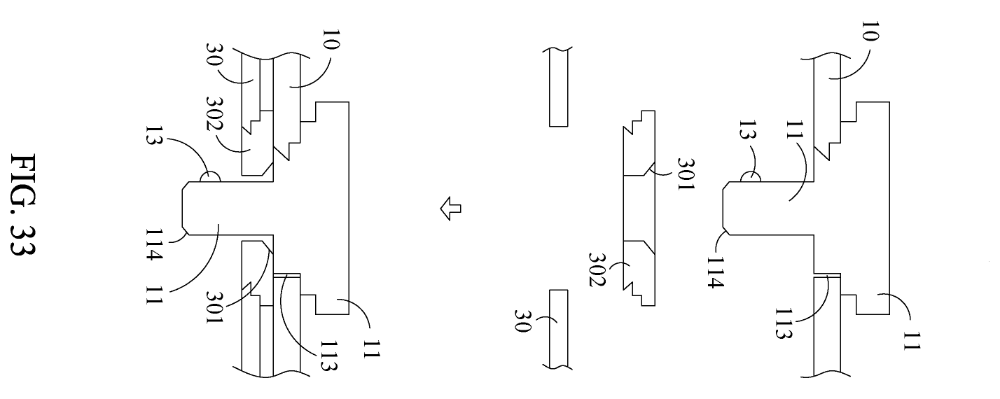

Referring to FIGS. 35-37, as shown in the figures, in addition to the foregoing embodiment, in an embodiment of the present disclosure, the embodiment differs from the foregoing embodiment in that the body portion 11 includes an operated portion 115, the stop portion 12 includes an operating portion 124, and the operating portion 124 is configured to operate the operated portion 115, so that the operated portion 115 is configured to operate the another fastening portion 17 to engage with or lock into the object 10. Therefore, the limiting structure 1 can meet an operation requirement in actual application.

In addition to the foregoing embodiment, in an embodiment of the present disclosure, the embodiment differs from the foregoing embodiment in that the operated portion 115 and the operating portion 124 may each be polygonal, hexagonal, multi-angled, rectangular, cross-shaped, non-circular, a convex portion, a concave portion, or an anti-rotation structure. Therefore, the operated portion 115 and the operating portion 124 can better meet requirements in actual assembly and application.

In addition to the foregoing embodiment, in an embodiment of the present disclosure, the embodiment differs from the foregoing embodiment in that the body portion 11 includes a tool operating portion 116, and the tool operating portion 116 is cross-shaped, rectangular, polygonal, non-circular, a convex portion, a concave portion, or an anti-rotation structure. In this way, the tool operating portion 116 may be operated with a proper tool by applying a force, so that the tool operating portion 116 drives the operated portion 115 to operate the another fastening portion 17 to engage with or lock into the object 10.

In addition to the foregoing embodiment, in an embodiment of the present disclosure, the embodiment differs from the foregoing embodiment in that the stop portion 12 includes a non-operating portion 125. The operated portion 115 enters the non-operating portion 125 after leaving a range of the operating portion 124. The non-operating portion 125 is located above or below the operating portion 124, so that the operated portion 115 can leave the operating portion 124 after being actuated. The stop portion 12 is moved downward to make the operated portion 115 enter the non-operating portion 125, and meanwhile, the fastening portion 13 is engaged with the limiting portion 121 for limiting. In this way, after the another fastening portion 17 engages with or locks into the object 10, a firm engagement requirement can be met.

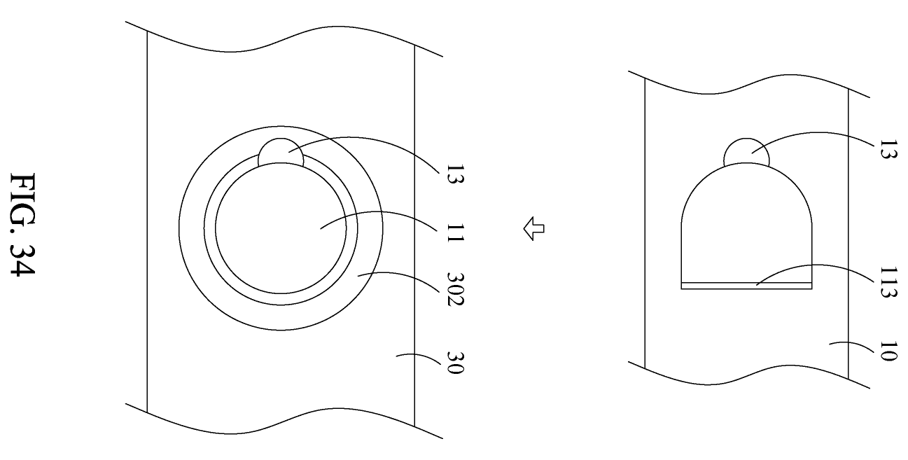

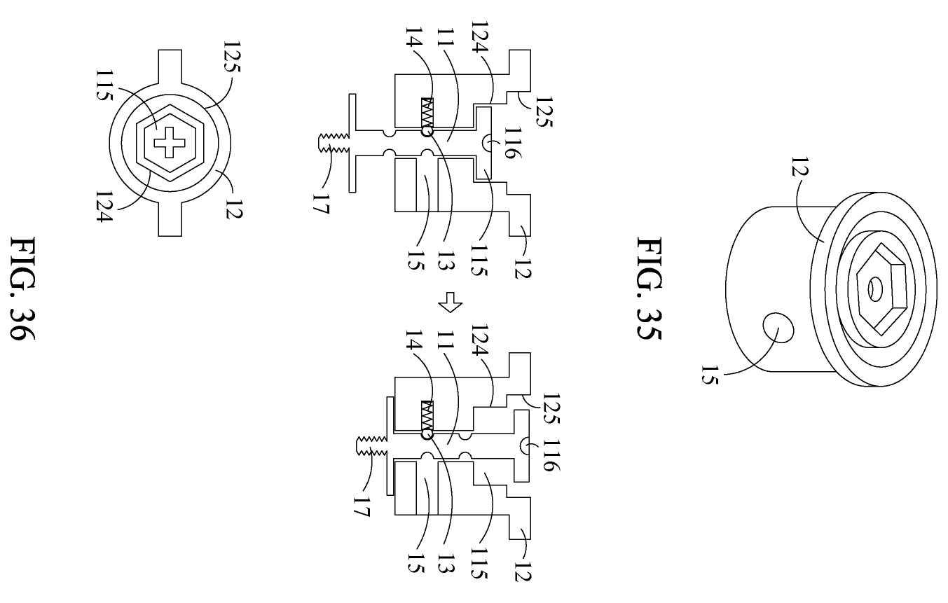

Referring to FIGS. 38-40, as shown in the figures, in addition to the foregoing embodiment, in an embodiment of the present disclosure, the embodiment differs from the foregoing embodiment in that the limiting portion 121 or the placement portion 16 is molded by injecting a liquid raw material inside a mold 40 through a flow channel 41 and then solidifying the liquid raw material. A space including an arrangement portion 15 inside the mold 40 is configured for molding through solidification after injection of the liquid raw material. In addition, a space including the limiting portion 121 or the placement portion 16 inside the mold 40 is configured for molding through solidification after injection of the liquid raw material.

In addition to the foregoing embodiment, in an embodiment of the present disclosure, the embodiment differs from the foregoing embodiment in that the limiting portion 121 or the placement portion 16 is an embedded piece 42 (or the placement portion 16 is an embedded piece), and the embedded piece 42 is placed inside the mold 40 and is configured for molding the body portion 11 or the stop portion 12 through solidification after injection of the liquid raw material. In a feasible embodiment, the body portion 11 or the stop portion 12 has the limiting portion 121 or the placement portion 16 molded inside the mold 40. In addition, the body portion 11 or the stop portion 12 is molded through solidification after being injected as a liquid raw material inside the mold 40. The liquid raw material is a plastic material or a metal material.

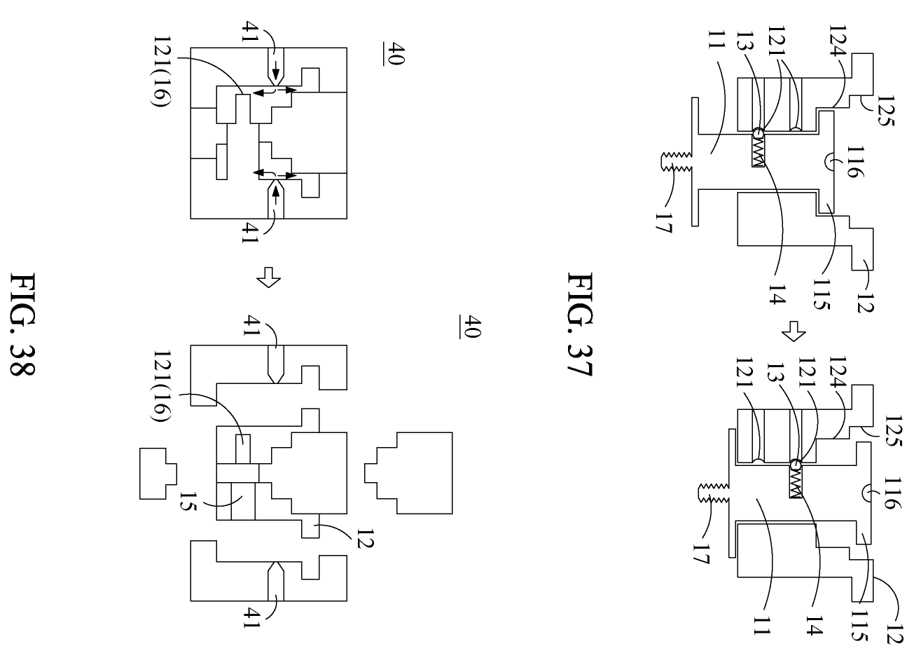

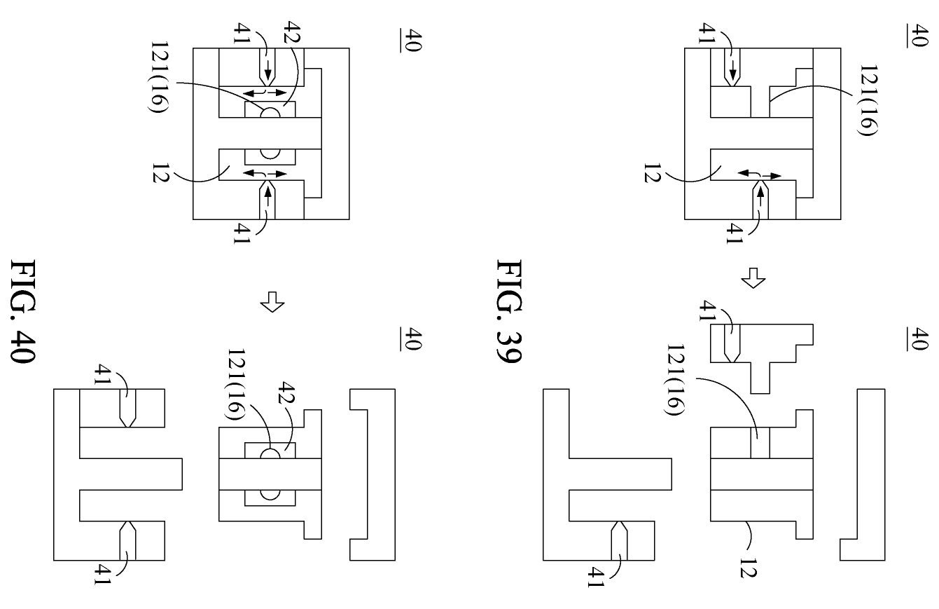

Referring to FIGS. 41 and 42, as shown in the figures, in addition to the foregoing embodiment, in an embodiment of the present disclosure, the embodiment differs from the foregoing embodiment in that the fastening portion 13 is arranged between the body portion 11 and the stop portion 12 and abutted against by the elastic element 14, and the elastic element 14 is arranged on the body portion 11 or the stop portion 12, where the body portion 11 or the stop portion 12 is a flat surface, an arc surface, or a horizontal surface, or configured to allow the stop portion 12 to stop or pause at any height or a specific height of the body portion 11 steplessly by using a pushing force or a friction force from the elastic element 14 during movement of the fastening portion 13.

In addition to the foregoing embodiment, in an embodiment of the present disclosure, the embodiment differs from the foregoing embodiment in that the body portion 11 includes another fastening portion 17 and the connecting portion 111, configured to engage with or connect to the object 10, where the object 10 is a printed circuit board, a heat-radiating apparatus, a chip, a metal body, or a housing, or the another fastening portion 17 or the connecting portion 111 is configured for lifting the object 10.

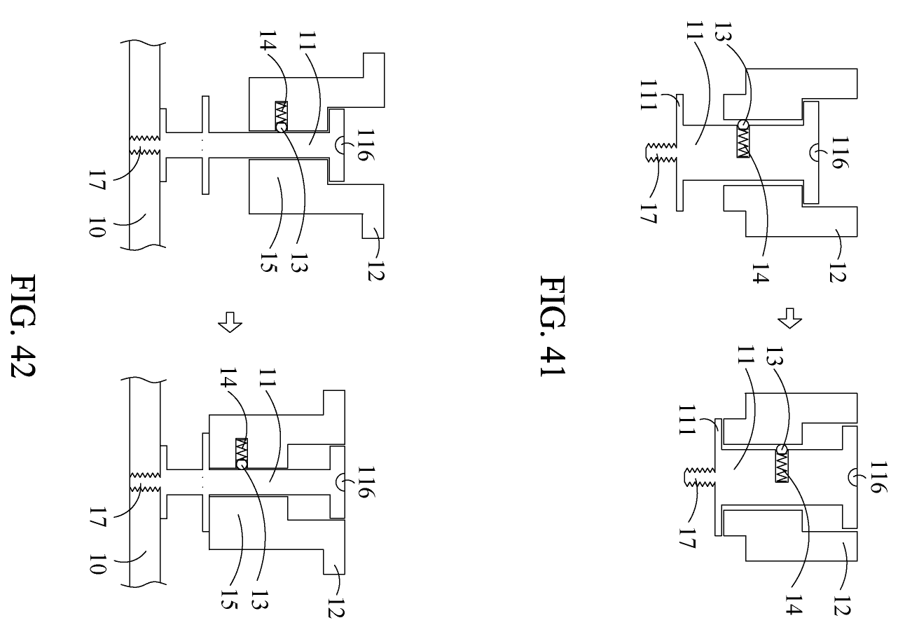

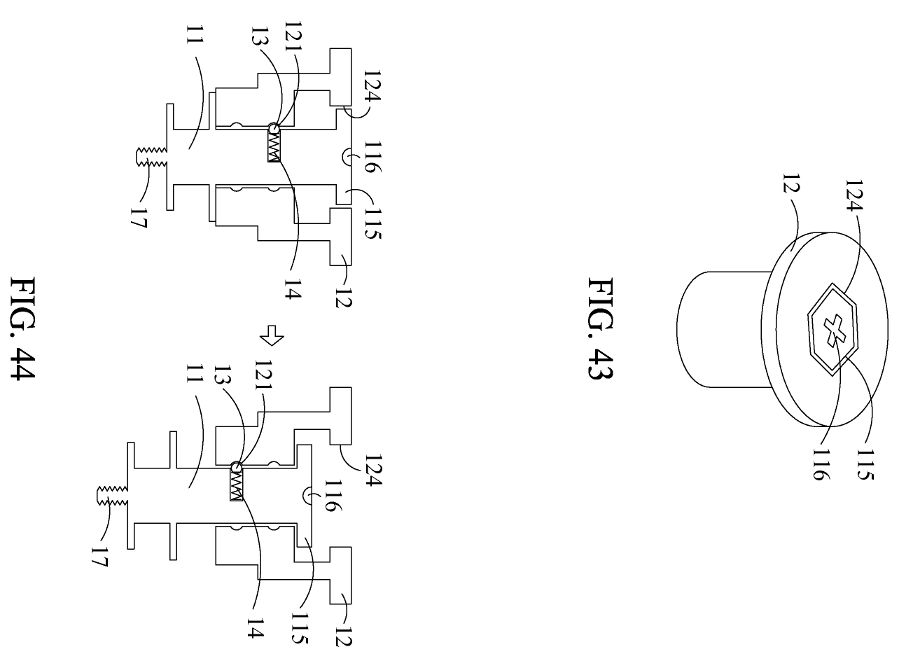

Referring to FIGS. 43-46, as shown in the figures, in addition to the foregoing embodiment, in an embodiment of the present disclosure, the embodiment differs from the foregoing embodiment in that the operating portion 124 and the operated portion 115 is arranged on the body portion 11 and configured to operate the body portion 11 and the another fastening portion 17. In addition, in a feasible embodiment, the body portion 11 may be the foregoing operating portion or operated portion, and may also be configured to operate the body portion 11 and the another fastening portion 17. Therefore, the limiting structure 1 can meet an operation requirement in actual application.

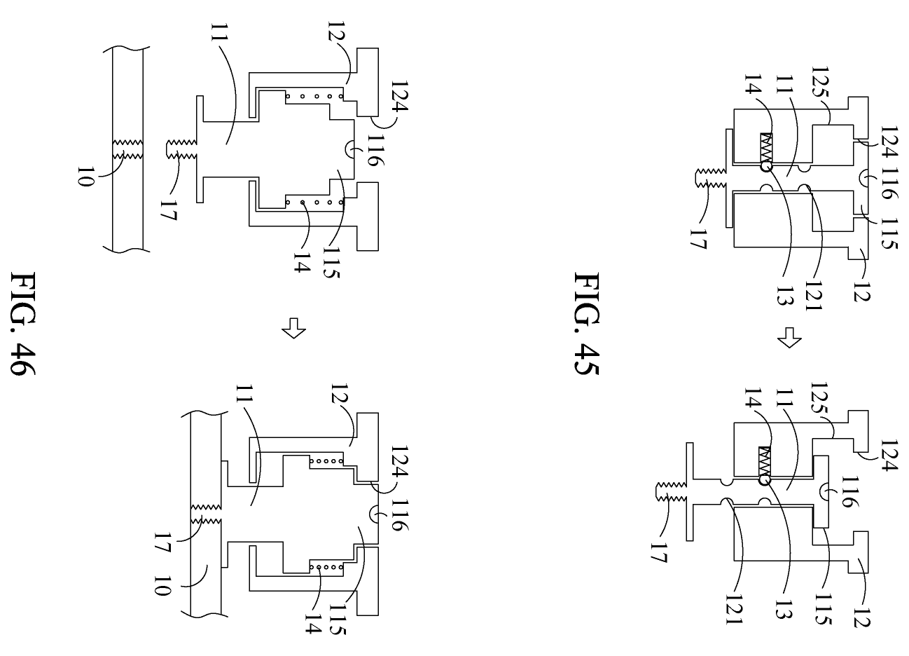

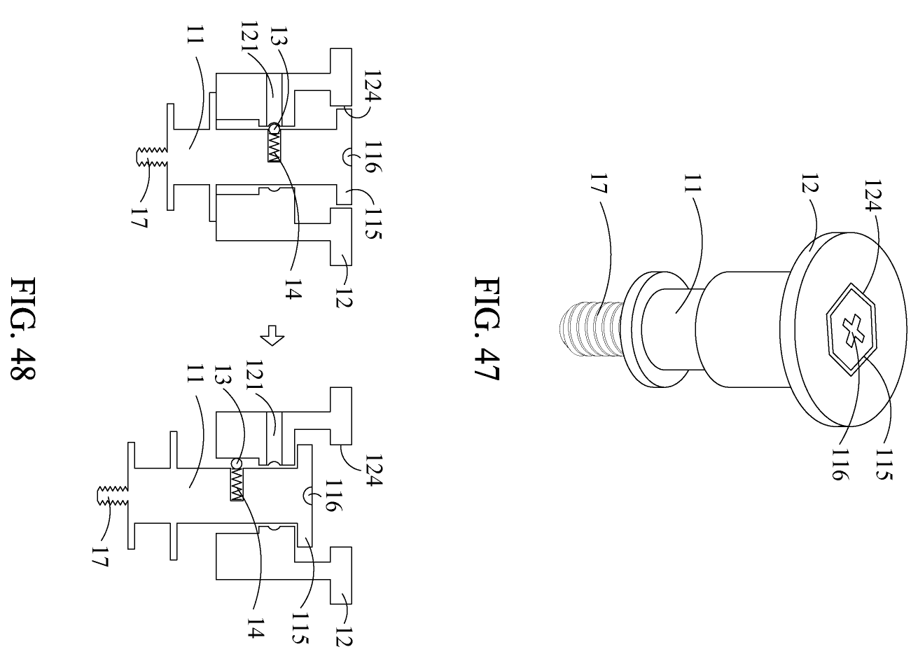

Referring to FIGS. 47-50, as shown in the figures, in addition to the foregoing embodiment, in an embodiment of the present disclosure, the embodiment differs from the foregoing embodiment in that a rotatable portion 126 larger than the operating portion 124 is provided below the operating portion 124, and configured to enable the operated portion 115 to rotate at the rotatable portion 126, so that the operated portion 115 is configured to operate the another fastening portion 17 to engage with or lock into the object 10. Therefore, the limiting structure 1 can meet an operation requirement in actual application.

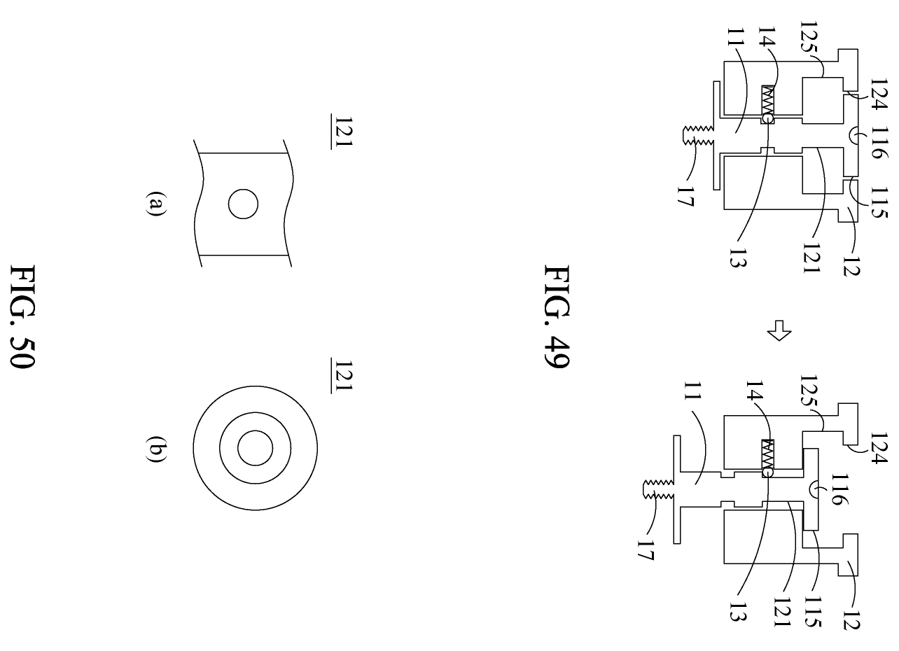

In addition to the foregoing embodiment, in an embodiment of the present disclosure, the embodiment differs from the foregoing embodiment in that the limiting portion 121 may be a hole portion (for example, a part a in FIG. 50), a groove portion, a convex portion, a concave portion, a step portion, an annular portion, or an annular groove portion (for example, a part b in FIG. 50).

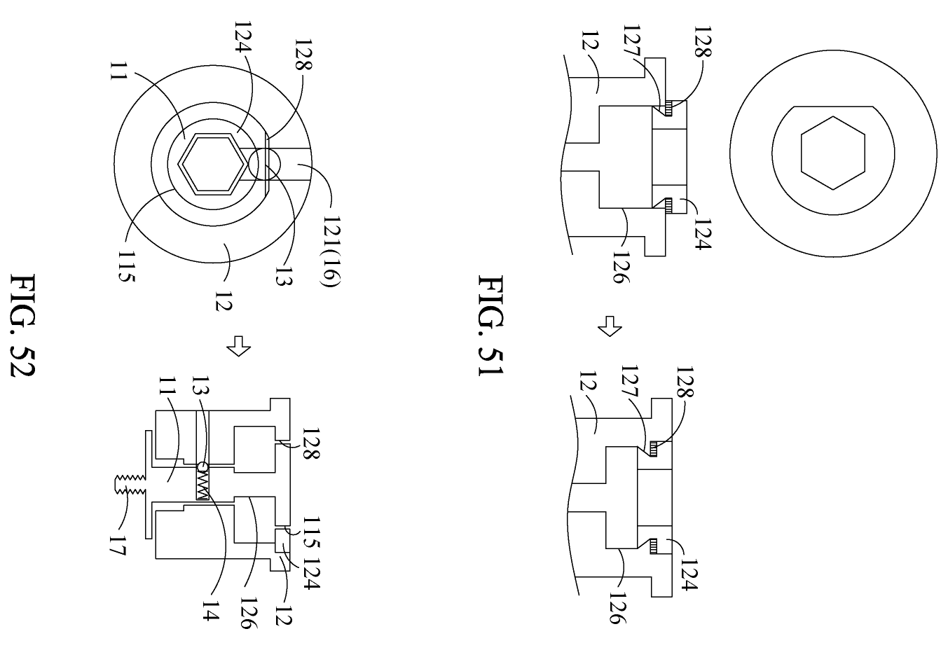

Referring to FIG. 51, as shown in the figure, in addition to the foregoing embodiment, in an embodiment of the present disclosure, the embodiment differs from the foregoing embodiment in that the operating portion 124 is connected to the stop portion 12, and the operating portion 124 is configured to be riveted to or engaged with the stop portion 12. In a feasible embodiment, the stop portion 12 includes a material entry portion 127, configured to apply an external force to press a material of the stop portion 12 to enter the material entry portion 127 for connection.

In addition to the foregoing embodiment, in an embodiment of the present disclosure, the embodiment differs from the foregoing embodiment in that the operating portion 124 includes a fifth anti-rotation portion 128, and the fifth anti-rotation portion 128 is configured to prevent rotation of the stop portion 12, or the fifth anti-rotation portion 128 is serrations or a flat surface.

Referring to FIG. 52, as shown in the figure, in addition to the foregoing embodiment, in an embodiment of the present disclosure, the embodiment differs from the foregoing embodiment in that the fifth anti-rotation portion 128 defines a direction of a limiting portion 121 of the operating portion 124 corresponding to the stop portion 12 or a direction of the placement portion 16 of the body portion 11, and is configured to limit the fastening portion 13 such that the fastening portion 13 corresponds to the limiting portion 121 when the operated portion 115 enters the operating portion 124. Therefore, the limiting structure 1 can meet an operation requirement in actual application.

The present disclosure has been described with exemplary embodiments above. However, a person skilled in the art should understand that the embodiments are only used to describe the present disclosure, and are not intended to limit the scope of the present disclosure. It should be noted that, any changes and replacements equivalent to the embodiments shall fall within the scope of the present disclosure. Therefore, the protection scope of the present disclosure shall be subject to the scope of the claims.

What is claimed is:

1. A limiting structure, comprising:
a body portion;
a stop portion, movably connected to the body portion;
a fastening portion, arranged at the body portion, the stop portion, or an object; or
an elastic element, wherein one end thereof abuts against the body portion, the stop portion, or the object, or an other end thereof abuts against the stop portion, the body portion, or the fastening portion.

2. The limiting structure according to claim 1, wherein the stop portion is at a spring-up position or a raised position, and configured to locate the fastening portion to at a non-snap-locked position or a non-limit position, or the elastic element is configured to raise or apply an elastic force to the stop portion, the body portion, the fastening portion, or the object.

3. The limiting structure according to claim 1, wherein the body portion or the stop portion comprises an arrangement portion, wherein the arrangement portion is configured to allow the fastening portion or the elastic element to pass through, for the fastening portion or the elastic element to reach a placement portion for arrangement; or the body portion or the stop portion comprises an arrangement portion, wherein the arrangement portion is configured to allow the fastening portion to pass through in a free-fall manner, for the fastening portion or the elastic element to reach a placement portion for arrangement; or the body portion or the stop portion comprises an arrangement portion, or is configured to allow a tool to pass the fastening portion or the elastic element through the arrangement portion, for the fastening portion or the elastic element to reach a placement portion for arrangement; or the fastening portion is an elastic body or an object having an elastic element, or the elastic element is a spring, a torsion spring, or an elastic columnar body.

4. The limiting structure according to claim 1, wherein a limiting portion is arranged on the body portion, or the limiting portion is configured to perform movable limiting together with the stop portion, or two or more body portions are provided; or the body portion is configured to be riveted to, expansion-connected to, welded to, locked to, or engaged with the body portion, or the body portion is integrally molded with the object; or the limiting structure is arranged on an object, or a connecting portion connected to the object is arranged on the limiting structure, or the object is a circuit board, a metal body, a plastic body, a chip, a heat-dissipating body, a heat-generating body, or a conductive body, or the limiting structure is a handle, a fastening body, a telescopic body, or a lifting body; or the fastening portion is integrally molded or molded in a combined manner, or the fastening portion is combined by using a combination portion, or the fastening portion applies elasticity with an elastic piece, or the fastening portion is an elastic body injection molded from plastic; or the fastening portion is a fastening body that moves horizontally by more than 180 degrees, or the fastening portion is a barbed structure, or is configured to apply a force to press down the stop portion to release the fastening portion.

5. The limiting structure according to claim 1, wherein a first anti-rotation portion for preventing rotation of the fastening portion is arranged on the stop portion, or the first anti-rotation portion and a limiting portion of the body portion are located in a same axial direction, or are configured to first prevent rotation and then perform limiting; or a first anti-rotation portion is arranged on the stop portion, or a second anti-rotation portion is arranged on the body portion, or a third anti-rotation portion is arranged on the fastening portion, or a fourth anti-rotation portion is arranged on an object, or the first anti-rotation portion, the second anti-rotation portion, the third anti-rotation portion, or the fourth anti-rotation portion is configured to limit a direction, a position, or an orientation; or a first anti-rotation portion is arranged on the stop portion, or a second anti-rotation portion is arranged on the body portion, or the first anti-rotation portion and the second anti-rotation portion are configured to prevent rotation of the stop portion and the body portion.

6. The limiting structure according to claim 1, wherein the stop portion is operated to raise the stop portion by more than 3 mm, or the stop portion is higher than a height of a heat-dissipating body, a memory, a chip, a main board, a connector, or an element arranged on an object, or the stop portion is configured to lift or operate the object; or the stop portion is moved to control movement of the fastening portion, or the fastening portion to be engaged with an object.

7. The limiting structure according to claim 1, wherein the fastening portion is configured to be engaged with or limited to a limiting portion of the stop portion, or the fastening portion is configured to be laterally or rotatably engaged with or limited to a limiting portion of the stop portion, or two limiting portions are provided, or one limiting portion is located at an upper position, or the other limiting portion is located a lower position or is configured to limit the fastening portion at the lower position or the upper position; or the limiting portion comprises a wide-hole portion and an entry portion that are in communication, or the limiting portion comprises a wide-hole portion, an entry portion, and another wide-hole portion that are in communication, or the fastening portion is located at a lower position of the wide-hole portion for limiting, or the fastening portion is located at an upper position of the entry portion for limiting; or the limiting portion is a through hole, a hole, a groove, a concave portion, or a convex portion smaller than the fastening portion; or the limiting portion is a hole portion, a groove portion, a convex portion, a concave portion, a step portion, an annular portion, or an annular groove portion.

8. The limiting structure according to claim 1, wherein the fastening portion is connected to the body portion or is integrally molded with the body portion, or the elastic element is connected to the body portion or the fastening portion, or the elastic element is integrally molded with the body portion or the fastening portion, or the fastening portion is combined with the body portion, or the fastening portion is integrally molded with the object, or the elastic element is combined with the body portion, or the elastic element is integrally molded with the object.

9. The limiting structure according to claim 1, wherein the body portion comprises an arrangement portion, the fastening portion or the elastic element passes through the arrangement portion to be arranged at a placement portion of the body portion, and is stopped and limited by the stop portion, or the fastening portion or the elastic element passes the arrangement portion to be arranged on a placement portion of the body portion and is further configured to be stopped and limited by the stop portion; the stop portion comprises an arrangement portion, the fastening portion or the elastic element passes through the arrangement portion to be arranged at a placement portion of the stop portion, and is stopped and limited by the body portion, or the fastening portion or the elastic element passes the arrangement portion to be arranged on a placement portion of the stop portion and is further configured to be stopped and limited by the body portion; or the fastening portion or the elastic element passes through the arrangement portion to be arranged at a placement portion of the body portion, or is configured for a tool to be combined with the fastening portion or the elastic element at the placement portion, and is configured to be stopped and limited by the stop portion; or the fastening portion or the elastic element passes through the arrangement portion to be arranged at a placement portion of the body portion for placement, combination, or limiting, or the stop portion comprises an arrangement portion, or the fastening portion or the elastic element passes through the arrangement portion to be arranged at a placement portion of the stop portion for placement, combination, or limiting; or the body portion comprises an arrangement portion, the fastening portion passes through the arrangement portion to reach a placement portion of the body portion, and then, the stop portion limits the fastening portion at the body portion.

10. The limiting structure according to claim 1, wherein the fastening portion is integrally molded with the body portion, or the fastening portion is configured to be engaged with another object; and the fastening portion is an externally threaded body, a columnar body, an outer fastening body, an inner fastening body, an internally threaded body, an elastic fastening body, a convex fastening body, a spherical body, a block body, a convex body, a concave body, a metal body, a plastic body, or an elastic element, or the stop portion comprises a guide portion, or the guide portion is an inclined surface, an arc surface, or a stepped surface, or the guide portion is configured to allow the fastening portion to roll into, fall into, drop into, or move into a placement portion.

11. The limiting structure according to claim 1, wherein the body portion or the stop portion comprises another fastening portion, wherein the another fastening portion is an externally threaded body, a columnar body, an outer fastening body, an inner fastening body, an internally threaded body, an elastic fastening body, a convex fastening body, a spherical body, or an elastic element.

12. The limiting structure according to claim 1, wherein a second anti-rotation portion is arranged on the body portion, and the second anti-rotation portion prevents rotation of the object, and is configured to limit a direction or a position of another object with which the fastening portion is engaged; or another guide portion is arranged on the body portion, and the another guide portion is configured to guide the body portion to enter the another object; or a corresponding guide portion is arranged on the another object, and the corresponding guide portion is configured to guide the body portion to enter the another object.

13. The limiting structure according to claim 1, wherein a second anti-rotation portion is arranged on the body portion, and the second anti-rotation portion prevents rotation of the object, and is configured to limit a direction or a position of another object with which the fastening portion is engaged, wherein a catch portion is arranged on the another object, and the catch portion is configured to be engaged with the fastening portion, or the catch portion is riveted to, expansion-connected to, locked to, welded to, or engaged with the another object, or the catch portion is integrally molded with the another object, or another guide portion is arranged on the body portion, and the another guide portion is configured to guide the body portion to enter the catch portion; or a corresponding guide portion is arranged on the catch portion, and the corresponding guide portion is configured to guide the body portion to enter, or the another guide portion or the corresponding guide portion is an inclined surface, a curved surface, an arc surface, a stepped surface, or a flat surface.

14. The limiting structure according to claim 1, wherein the body portion comprises an operated portion, and the stop portion comprises an operating portion, or the operating portion is configured to operate the operated portion, or the operated portion is configured to operate another fastening portion to engage with or lock into the object, or the operated portion or the operating portion is polygonal, hexagonal, multi-angled, rectangular, cross-shaped, non-circular, a convex portion, a concave portion, or an anti-rotation structure; or the stop portion comprises a non-operating portion, and the operated portion enters the non-operating portion after leaving a range of the operating portion, or the non-operating portion is located above or below the operating portion; the operating portion is connected to the stop portion, or the operating portion is configured to be riveted to or engaged with the stop portion, or the stop portion comprises a material entry portion, or is configured to apply an external force to press a material of the stop portion to enter the material entry portion for connection, or the operating portion comprises a fifth anti-rotation portion, or the fifth anti-rotation portion is configured to prevent rotation of the stop portion, or the fifth anti-rotation portion is serrations or a flat surface; or the fifth anti-rotation portion defines a direction of a limiting portion of the operating portion corresponding to the stop portion or a direction of the placement portion of the body portion, or is configured to limit the fastening portion such that the fastening portion corresponds to the limiting portion when the operated portion enters the operating portion.

15. The limiting structure according to claim 1, wherein the stop portion comprises an operating portion, or a rotatable portion larger than the operating portion is provided below the operating portion, or configured to enable the operated portion to rotate at the rotatable portion; or the body portion comprises a tool operating portion, or the tool operating portion is cross-shaped, rectangular, polygonal, non-circular, a convex portion, a concave portion, or an anti-rotation structure; or the body portion is an operating portion or operated portion configured to operate the body portion or another fastening portion.

16. The limiting structure according to claim 1, wherein the stop portion comprises a limiting portion or a placement portion, or the body portion comprises a limiting portion or a placement portion, and the limiting portion or the placement portion is molded by injecting a liquid raw material inside a mold and then solidifying the liquid raw material; or a space comprising an arrangement portion inside the mold is configured for molding through solidification after injection of the liquid raw material; or a space comprising the limiting portion or the placement portion inside the mold is configured for molding through solidification after injection of the liquid raw material; or the limiting portion or the placement portion is an embedded piece, and the embedded piece is placed inside the mold and is configured for molding the body portion or the stop portion through solidification after injection of the liquid raw material; or the body portion or the stop portion has the limiting portion or the placement portion molded inside the mold; or the body portion or the stop portion is molded through solidification after being injected as a liquid raw material inside the mold; or the liquid raw material is a plastic material or a metal material.

17. The limiting structure according to claim 1, wherein the fastening portion is arranged between the body portion and the stop portion and abutted against by the elastic element, or the elastic element is arranged on the body portion or the stop portion, or the body portion or the stop portion is a flat surface, an arc surface, or a horizontal surface, or configured to allow the stop portion to stop or pause at any height or a specific height of the body portion steplessly by using a pushing force or a friction force from the elastic element during movement of the fastening portion.

18. The limiting structure according to claim 1, wherein the body portion comprises another fastening portion or a connecting portion, configured to engage with or connect to the object, or the object is a printed circuit board, a heat-radiating apparatus, a chip, a metal body, or a housing, or the another fastening portion or the connecting portion is configured for lifting the object.
